(19) United States
(12) Patent Application Publication
(10) Pub. No.: US 2024/0151255 A1
(43) Pub. Date: May 9, 2024

(54) METAL ELEMENT, JOINING STRUCTURE OF METAL ELEMENT TO METAL PLATE, JOINING STRUCTURE OF METAL ELEMENT TO DISSIMILAR MATERIAL PLATES MADE OF RESIN, METAL, AND THE LIKE, JOINED ARTICLE, AND METHOD FOR MANUFACTURING JOINED ARTICLE

(71) Applicant: Aoyama Seisakusho CO.,LTD., Niwa-gun (JP)

(72) Inventor: Tsuyoshi Kojima, Niwa-gun (JP)

(21) Appl. No.: 18/502,128

(22) Filed: Nov. 6, 2023

(30) Foreign Application Priority Data
Nov. 7, 2022 (JP) 2022-178442
Nov. 7, 2022 (JP) 2022-178443
Apr. 26, 2023 (JP) 2023-072744

(51) Int. Cl. F16B 19/10; F16B 37/06

(52) U.S. Cl. CPC F16B 19/10; F16B 37/068

(57) ABSTRACT

Provided is an element that allows being rigidly joined to a metal plate without adding a shape difficult to machine (a shape required for joining) in advance. An element 1 includes a flange-shaped part 2 and a columnar part 3 having a smaller diameter than the flange-shaped part 2. In a state where the columnar part 3 is inserted into an insertion hole 12 drilled in the metal plate 11, by applying pressure in an axial direction to deform and flow the metal plate 11 in a compression direction at the flange-shaped part 2 and to deform a part at a distal end edge of the columnar part 3 to expand in diameter to receive a deformed and flowed metal, so as to allow the element 1 to be joined to the metal plate 11 made of metal.

### CROSS-REFERENCE TO RELATED APPLICATION

This application claims priority from Japanese Patent Application No. 2022-178442 filed on Nov. 7, 2022, No. 2022-178443 filed on Nov. 7, 2022, and No. 2023-072744 filed on Apr. 26, 2023 with the Japan Patent Office, the entire contents of which are hereby incorporated by reference.

### BACKGROUND

### 1. Technical Field

The present invention relates to a metal member (element) for being joined to a plate material made of metal and a joining structure thereof. Moreover, the present invention relates to a metal member (element) for being joined to a plate material made of resin or metal and a joining structure thereof. Furthermore, the present invention relates to a joined article and a method for manufacturing the joined article.

### 2. Related Art

### Background Art Related to First Group of Inventions (Claims 1 to 4)

In manufacturing vehicle bodies and the like of automobiles, a plate material made of steel material, such as a high tensile strength steel plate, and a plate material made of light alloy, such as aluminum alloy, are stacked and fixed together in some cases. As a method for fixing such plate materials made of dissimilar metals to one another, there has been employed a method in which an element (rivet) made of steel material is fitted and secured into a plate material made of light alloy, and the element part is fused to the plate material made of steel material by a method, such as resistance welding.

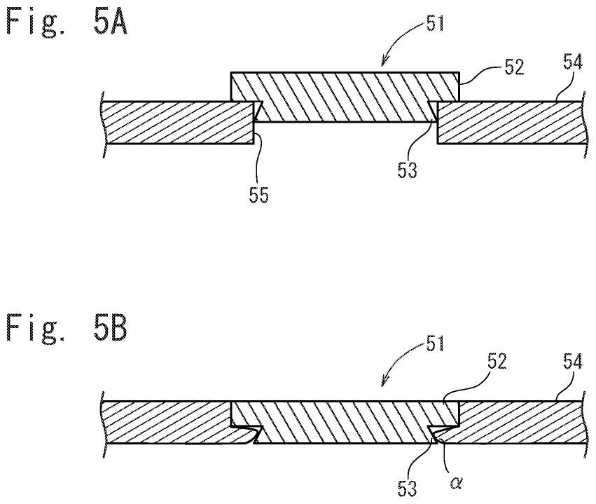

Moreover, as described above, as a method for fitting and securing an element made of steel material into a plate material made of light alloy in fixing plate materials made of dissimilar metals to one another, as illustrated in FIGS. 5A and 5B, there has been known a method for pressing an element, in which a part on the lower side of a flat columnar flange is formed into a truncated cone shape, into a plate material made of light alloy. That is, as illustrated in FIG. 5A, in a state where the part in a truncated cone shape of the element is inserted into an insertion hole drilled in the plate material made of light metal, by applying pressure in an axial direction and pressing the flange of the element into the insertion hole of the plate material, a peripheral area of the insertion hole is plastically deformed. Then, as illustrated in FIG. 5B, by causing the plastically deformed metal to enter a gap formed by an upper surface of the part in a truncated cone shape and a lower surface of the flange, the element is secured so as not to come off the plate material.

Furthermore, as a method for fitting and securing an element made of steel material into a plate material made of light alloy, as disclosed in Japanese Patent No. 6010739, there has been devised a method for securing an element so as not to come off a plate material by causing a plastically deformed metal to enter a depressed-shaped part of a shaft portion of the element. The metal is plastically deformed by pressing the element, in which an outer peripheral surface of the shaft portion on the lower side of a flange is curved in a depressed shape to decrease in a diameter of an intermediate part of the shaft portion, into a plate material made of light alloy.

### Background Art Related to Second Group of Inventions (Claims 5 to 8)

In manufacturing vehicle bodies and the like of automobiles, a plate material made of steel material, such as a high tensile strength steel plate, and a plate material made of light alloy, such as aluminum alloy, are stacked and fixed together in some cases. As a method for fixing such plate materials made of dissimilar metals to one another, there has been employed a method in which an element (rivet) made of steel material is fitted and secured into a plate material made of light alloy, and the element part is fused to the plate material made of steel material by a method, such as resistance welding.

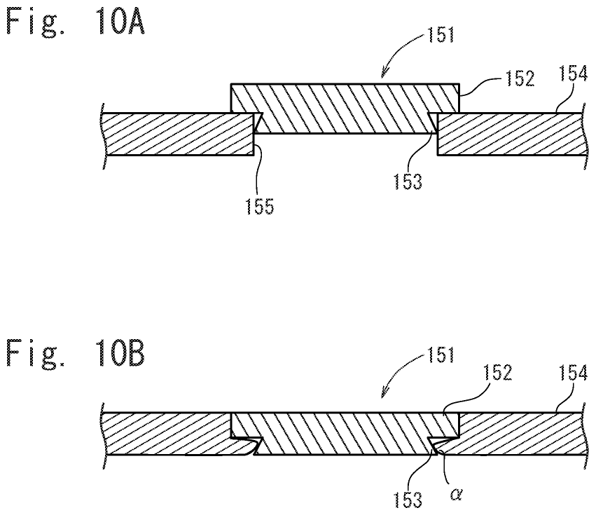

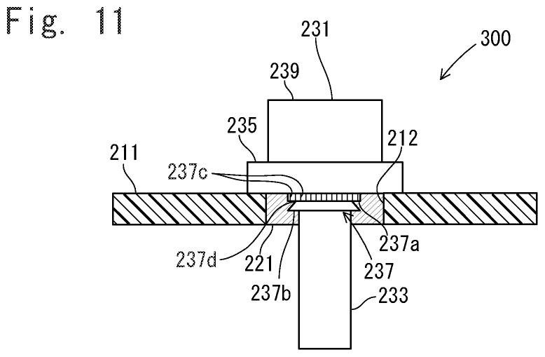

Moreover, as described above, as a method for fitting and securing an element made of steel material into a plate material made of light alloy in fixing plate materials made of dissimilar metals to one another, as illustrated in FIGS. 10A and 10B, there has been known a method for pressing an element 151, in which a part on the lower side of a flat columnar flange 152 is formed into a truncated cone shape, into a plate material 154 made of light alloy. That is, as illustrated in FIG. 10A, in a state where a truncated cone-shaped part 153 of the element 151 is inserted into an insertion hole 155 drilled in the plate material 154 made of light metal, by applying pressure in the axial direction and pressing the flange 152 of the element 151 into the insertion hole 155 of the plate material 154, a peripheral area of the insertion hole 155 is plastically deformed. Then, as illustrated in FIG. 10B, by causing the plastically deformed metal to enter a gap formed by an upper surface of the truncated cone-shaped part 153 and a lower surface of the flange 152, the element 151 is secured so as not to come off the plate material 154.

Furthermore, as a method for fitting and securing an element made of steel material into a plate material made of light alloy, as disclosed in Japanese Patent No. 6010739, there has been devised a method for securing an element so as not to come off a plate material by causing a plastically deformed metal to enter a depressed-shaped part of a shaft portion of the element. The metal is plastically deformed by pressing the element, in which an outer peripheral surface of the shaft portion on the lower side of a flange is curved in a depressed shape to decrease in a diameter of an intermediate part of the shaft portion, into a plate material made of light alloy.

### Background Art Related to Third Group of Inventions (Claims 9 to 12)

In JP-A-2022-058074, a stud bolt composed of a head portion, a screw shaft portion, and an intermediate flange portion positioned therebetween is exemplified as one example of a fastening member, and a securing method for securing the stud bolt to a prepared hole provided in a mating material is disclosed. In the securing method, the stud bolt is secured to the mating material so as to sandwich the mating material by the head portion and the intermediate flange portion by pressing the intermediate flange portion of the stud bolt into an inside of the prepared hole of the mating material and pressing to flatten the head portion in a state where the head portion of the stud bolt is allowed to project from the prepared hole of the mating material.

### SUMMARY

### <Problem to be Solved by First Group of Inventions (Claims 1 to 4)>

However, the method for fitting and securing an element having a shaft portion formed into a conical shape into a plate material made of light alloy as illustrated in FIGS. 5A and 5B and the method for fitting and securing an element, in which an outer peripheral surface of a shaft portion is curved in a depressed shape to decrease in diameter of an intermediate part of the shaft portion, into a plate material made of light alloy as disclosed in Japanese Patent No. 6010739 require fine adjustment of a diameter of a hole drilled in the plate material made of light alloy in order to rigidly fix the element to the plate material made of light alloy so that the element does not fall out. When the diameter decreases only slightly, an extremely large force is necessary for press fitting. Conversely, when the diameter increases only slightly, rigidly fixing so as not to fall out of the plate material becomes difficult.

### <Object of First Group of Inventions (Claims 1 to 4)>

It is an object of the first group of inventions (claims 1 to 4) to solve the above-described problem in the conventional element and provide an element that allows being rigidly joined to a metal plate without requiring fine adjustment of a hole diameter of an insertion hole drilled in the metal plate. Moreover, it is an object of the present invention to solve the above-described problem in the conventional joining method between an element and a metal plate and provide a joining method of an element to a metal plate that allows rigidly joining the element to the metal plate without requiring fine adjustment of a hole diameter of an insertion hole drilled in the metal plate.

### <Problem to be Solved by Second Group of Inventions (Claims 5 to 8)>

However, the method for fitting and securing an element having a shaft portion formed into a conical shape into a plate material made of light alloy as illustrated in FIGS. 10A and 10B and the method for fitting and securing an element, in which an outer peripheral surface of a shaft portion is curved in a depressed shape to decrease in diameter of an intermediate part of the shaft portion, into a plate material made of light alloy as disclosed in Japanese Patent No. 6010739 require fine adjustment of a diameter of a hole drilled in the plate material made of light alloy in order to rigidly fix the element to the plate material made of light alloy so that the element does not fall out. When the diameter decreases only slightly, an extremely large force is necessary for press fitting. Conversely, when the diameter increases only slightly, rigidly fixing so as not to fall out of the plate material becomes difficult.

### <Object of Second Group of Inventions (Claims 5 to 8)>

It is an object of the second group of inventions (claims 5 to 8) to solve the above-described problem in the conventional element and provide an element that allows being rigidly joined to a resin plate or metal plate without significantly deforming the resin plate or metal plate to which the element is joined. Moreover, it is an object of the present invention to solve the above-described problem in the conventional joining method between an element and a resin plate or metal plate and provide a joining method of an element to a resin plate or metal plate that allows rigidly joining the element to the resin plate or metal plate without significantly deforming the resin plate or metal plate to which the element is joined.

### <Problem to be Solved by Third Group of Inventions (Claims 9 to 12)>

The technique according to JP-A-2022-058074 is a technique that requires a fastening member itself to be significantly deformed and a technique that imposes a large constraint on the fastening member. On the other hand, examples of a method for joining a fastening member in a form that does not cause significant deformation includes a method for joining using a heat source, a solvent adhesive, or the like. However, with this method, there is a concern over disadvantages by using a heat source, a solvent adhesive, or the like, and for example, the heat source or the solvent adhesive may have an influence on a metal plate or resin plate as a joint target plate.

### <Object of Third Group of Inventions (Claims 9 to 12)>

It is an object of the third group of inventions (claims 9 to 12) to solve the above-described problem in the conventional joined article and provide a technique that allows rigidly securing a fastening part to a resin plate or metal plate while reducing or not requiring the use of a heat source, a solvent adhesive, or the like.

### <Means to Solve Problem Related to First Group of Inventions (Claims 1 to 4)>

In the present invention, an invention described in claim 1 is a metal element to be joined to a metal plate. The metal element includes a flange-shaped part and a columnar part having a smaller diameter than the flange-shaped part. In a state where the columnar part is inserted into an insertion hole drilled in the metal plate, by applying pressure in an axial direction to deform and flow the metal plate in a compression direction at the flange-shaped part and to deform a part at a distal end edge of the columnar part to expand in diameter such that the columnar part receives the deformed and flowed metal (that is, by allowing the metal element itself to plastically deform simultaneously with plastic deformation of the metal plate), so as to join the metal element to the metal plate.

The invention described in claim 2 is the invention described in claim 1 in which a depressed-shaped portion is formed on a distal end surface of the columnar part.

The invention described in claim 3 is the invention described in claim 1 or 2 in which the flange-shaped part is formed into an inverted truncated cone shape.

An invention described in claim 4 is a joining structure for joining a metal element to a metal plate. The joining structure includes a flange-shaped part and a columnar part having a smaller diameter than the flange-shaped part. In a state where the columnar part of the metal element is inserted into an insertion hole drilled in the metal plate, by applying pressure to the metal element in an axial direction to deform and flow the metal plate in a compression direction at the flange-shaped part and to deform a part at a distal end edge of the columnar part to expand in diameter to receive a deformed and flowed metal (that is, by allowing the metal element itself to plastically deform simultaneously with plastic deformation of the metal plate), so as to join the metal element to the metal plate.

### <Means to Solve Problem Related to Second Group of Inventions (Claims 5 to 8)>

In the present invention, an invention described in claim 5 is a metal element to be joined to a resin plate or metal plate. The metal element includes a columnar part, and a surface of the columnar part has a non-flat shape. In a state where the columnar part is inserted into an insertion hole drilled in a resin plate or metal plate, by applying pressure in an axial direction to expand a diameter of the columnar part and to bring the columnar part into pressure contact with only an inner surface of the insertion hole of the resin plate or metal plate, so as to join the metal element to the resin plate or metal plate. Note that the “non-flat shape” in the present invention means a state of having unevenness by having protrusions or grooves formed. The metal element according to the present invention may be one having a columnar shape (or cylindrical shape) in whole or may be one having a columnar shape (or cylindrical shape) in part.

The invention described in claim 6 is the invention described in claim 5 in which a surface of the columnar part is provided by diamond-pattern uneven processing.

The invention described in claim 7 is the invention described in claim 5 or 6 in which the columnar part is hollow or has both front and back surfaces or one surface formed into a depressed shape.

The invention described in claim 8 is a joining structure for joining a metal element to a resin plate or metal plate. The metal element includes a columnar part. A surface of the columnar part has a non-flat shape. In a state where the metal element is inserted into an insertion hole drilled in a resin plate or metal plate, by applying pressure in an axial direction to expand a diameter of the columnar part of the metal element and to bring the columnar part into pressure contact with only an inner surface of the insertion hole drilled in the resin plate or metal plate, so as join the metal element to the resin plate or metal plate.

### <Means to Solve Problem Related to Third Group of Inventions (Claims 9 to 12)>

In the present invention, the invention described in claim 9 is a joined article includes an annular metal element to be joined to a resin plate or metal plate having an insertion hole; and a fastening member. In a state where the metal element is inserted through the insertion hole and in a state where the fastening member is inserted through the metal element, by compressing the metal element to increase an outer diameter and decrease an inner diameter of the metal element, so as to join the metal element to an inner surface of the insertion hole to be coupled to the fastening member.

The invention described in claim 10 is the invention described in claim 9 in which the fastening member includes a shaft portion to be inserted through the metal element, and a male thread portion is disposed in at least a part of a region, and the region lies out of the metal element in the shaft portion.

The invention described in claim 11 is the invention described in claim 9 in which a groove portion is formed in the fastening member, and in a state where the metal element is inserted through the insertion hole and in a state where an end portion of the metal element enters the groove portion, by compressing the metal element to increase an outer diameter and decrease an inner diameter of the metal element, the metal element is joined to an inner surface of the insertion hole to be coupled to the fastening member.

The invention described in claim 12 is a manufacturing method for manufacturing a joined article in which an annular metal element and a fastening member are joined to a resin plate or metal plate including an insertion hole. The manufacturing method includes in a state where the metal element is inserted through the insertion hole and in a state where the fastening member is inserted through the metal element, compressing the metal element to increase an outer diameter and decrease an inner diameter of the metal element, so as to join the metal element to an inner surface of the insertion hole to be coupled to the fastening member.

### <Effects of First Group of Inventions (Claims 1 to 4)>

The metal element (hereinafter also referred to simply as an element) according to claim 1 is fitted to a shape of the metal plate after plastic deformation by causing the columnar part to plastically deform by the pressure in the axial direction. Accordingly, the metal element can be rigidly joined to the metal plate without providing a retaining shape that expands in diameter to a cylindrical tubular portion in advance.

Since the metal element according to claim 2 has a depressed-shaped portion formed on a distal end surface of the columnar part, a distal end part of the columnar part easily deforms to expand in diameter when pressure is applied in the axial direction. Accordingly, the metal element is easily fitted to a shape of the metal plate after plastic deformation and, therefore, can be joined to the metal plate more rigidly.

The metal element according to claim 3 has the flange-shaped part formed into an inverted truncated cone shape and easily enters an insertion hole of a metal object. By allowing the metal element to have a minimal volume necessary to promote the metal object to plastically deform, the metal element can be deformed easily by a small pressure so as to have the same thickness as the metal plate (that is, such that both front and back surfaces are flush with the metal plate).

With the joining structure of a metal element to a metal plate according to claim 4, the metal element is fitted to a shape of the metal plate after plastic deformation by causing the columnar part of the metal element to plastically deform by the pressure in the axial direction. Accordingly, the cylindrical tubular portion can be rigidly joined to the metal plate without providing difficult machining to make a shape that expands in diameter in manufacturing the metal element, therefore facilitating the manufacturing of the metal element.

<Effects of Second Group of Inventions (claims 5 to 8)>

The metal element (hereinafter also referred to simply as an element) according to claim 5 is fitted to a shape of the resin plate or metal plate after plastic deformation by causing the columnar part to plastically deform by the pressure in the axial direction. Accordingly, the metal element can be rigidly joined to the resin plate or metal plate. In the metal element according to claim 5, a surface of the columnar part has a non-flat shape. Accordingly, when the columnar part plastically deforms by the pressure in the axial direction, a protrusion-shaped part of the columnar part digs into the resin plate or metal plate, and the plastically deformed resin plate or metal plate digs into a depressed-shaped part of the columnar part. Therefore, the metal element can be joined to the resin plate or metal plate very rigidly.

In the metal element according to claim 6, a surface of the columnar part is provided by diamond-pattern uneven processing. Accordingly, over a wide area on the surface of the columnar part, the protrusion-shaped part digs into the resin plate or metal plate, and the plastically deformed resin plate or metal plate digs into the depressed-shaped part. Therefore, the metal element can be joined to the resin plate or metal plate extremely rigidly.

In the metal element according to claim 7, the columnar part is hollow or has both front and back surfaces or one surface formed into a depressed shape. Accordingly, since a load is dispersed to the hollow part or the depressed-shaped part when pressure is applied in the axial direction, the load for expanding the diameter of the columnar part can be reduced. Further, since a compression ratio of the metal element itself can be enhanced, joining to a thin plate becomes possible.

With the joining structure of a metal element to a metal plate according to claim 8, the columnar part of the metal element plastically deforms only in a diameter expanding direction and an inner diameter direction when pressure is applied in the axial direction and does not plastically deform in directions other than a direction of coming into pressure contact with the inner surface of the insertion hole drilled in the resin plate or metal plate. Accordingly, the metal element can be joined to the resin plate or metal plate very rigidly.

### <Effects of Third Group of Inventions (Claims 9 to 12)>

In the joined article according to claim 9, the fastening member can be secured utilizing plastic deformation of the metal element by compression. Accordingly, the fastening member can be joined to the resin plate or metal plate while the use of a heat source, a solvent adhesive, or the like is reduced or not required. In particular, the above-described joined article has undergone plastic deformation that increases the outer diameter in the metal element in the state where the metal element is inserted through the insertion hole. Accordingly, an outer peripheral portion of the metal element easily comes in close contact with an inner peripheral portion of the insertion hole strongly. Even when the use of a heat source, a solvent adhesive, or the like is reduced or not required, joining between the resin plate or metal plate and the metal element is easily maintained rigidly. Furthermore, the joined article has undergone plastic deformation that decreases the inner diameter of the metal element in the state where the fastening member is inserted through the metal element. Accordingly, an inner peripheral portion of the metal element easily comes in close contact with the fastening member strongly. Even when the use of a heat source, a solvent adhesive, or the like is reduced or not required, coupling between the metal element and the fastening member is easily maintained rigidly.

In the joined article according to claim 10, the fastening member having a male thread portion can be integrated with the resin plate or metal plate while the use of a heat source, a solvent adhesive, or the like is reduced or not required. In particular, the above-described joined article has a structure in which the inner diameter of the metal element decreases to tighten the shaft portion by the plastic deformation in the state where the shaft portion is inserted through the metal element. Accordingly, the metal element can be rigidly joined to the shaft portion. Furthermore, the male thread portion can be disposed in a region, which lies out of the metal element, in the shaft portion of the fastening member, that is, a region that does not contribute to the joining to the metal element. Accordingly, the fastening member can be configured integrally with the resin plate or metal plate, and the male thread portion can be preferably disposed in the integrated object.

In the joined article according to claim 11, the metal element is joined to the fastening member by the plastic deformation in the groove portion by compressing the metal element. Accordingly, joining between a part of the fastening member arranged in the groove portion and the groove portion is easily maintained rigidly. Furthermore, as long as the fastening part allows the groove portion to be formed, there is an advantage that joining with a heat source, a solvent adhesive, or the like reduced can be achieved.

With the manufacturing method according to claim 12, the fastening member can be secured utilizing plastic deformation of the metal element by compression. Accordingly, the joined article can be manufactured so as to join the fastening member to the resin plate or metal plate while reducing or not requiring the use of a heat source, a solvent adhesive, or the like. With the manufacturing method, in the state where the metal element is inserted through the insertion hole, plastic deformation is performed so as to increase the outer diameter of the metal element. Accordingly, the outer peripheral portion of the metal element can be kept in close contact with the inner peripheral portion of the insertion hole strongly, and joining between the resin plate or metal plate and the metal element is easily maintained rigidly. Furthermore, with the above-described manufacturing method, in the state where the fastening member is inserted through the metal element, plastic deformation is performed so as to decrease the inner diameter of the metal element. Accordingly, the inner peripheral portion of the metal element can be kept in close contact with the fastening member strongly, and coupling between the metal element and the fastening member is easily maintained rigidly.

### BRIEF DESCRIPTION OF DRAWINGS

### Drawings Related to First Group of Inventions (Claims 1 to 4)

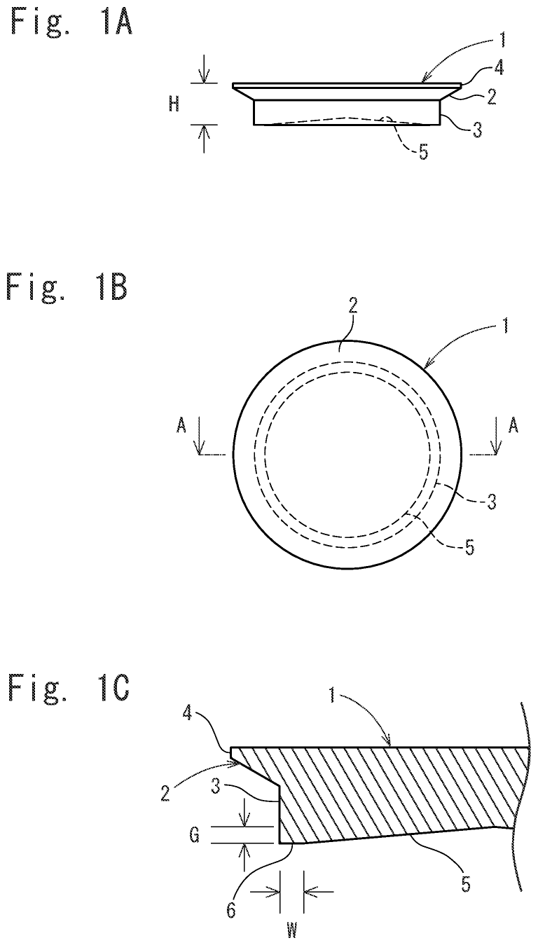

FIGS. 1A to 1C are explanatory views illustrating an element (A is a front view, B is a plan view, and C is an enlarged view of a part (part on the left side) of a cross-sectional view taken along a line A-A of B);

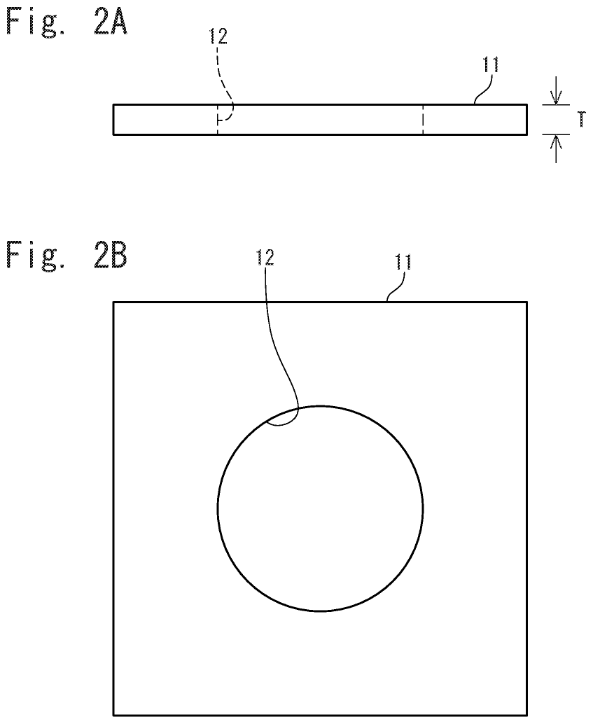

FIGS. 2A and 2B are explanatory views illustrating a metal plate to which the element is joined (A is a front view, and B is a plan view);

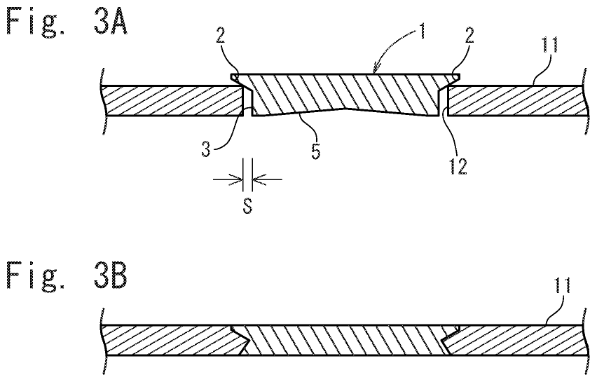

FIGS. 3A and 3B are explanatory views illustrating a state where the element is joined to the metal plate;

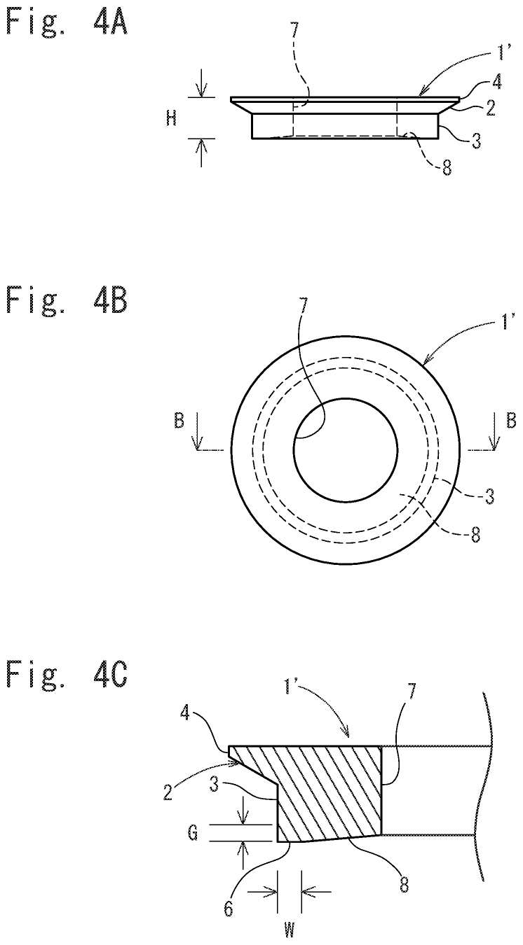

FIGS. 4A to 4C are explanatory views illustrating a modification of the element (A is a front view, B is a plan view, and C is an enlarged view of a part (part on the left side) of a cross-sectional view taken along a line B-B of B); and

FIGS. 5A and 5B are explanatory views illustrating a state where an element is joined to a metal plate by a conventional method.

### Drawings Related to Second Group of Inventions (Claims 5 to 8)

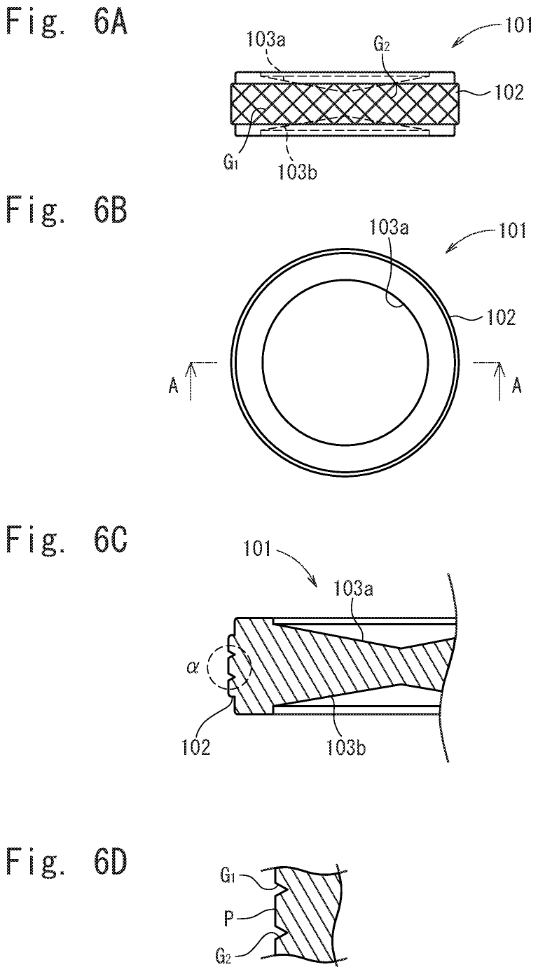

FIGS. 6A to 6D are explanatory views illustrating an element (A is a front view, B is a plan view, C is an enlarged view of a part (part on the left side) of a cross-sectional view taken along a line A-A of B, and D is an enlarged view of a part a of C);

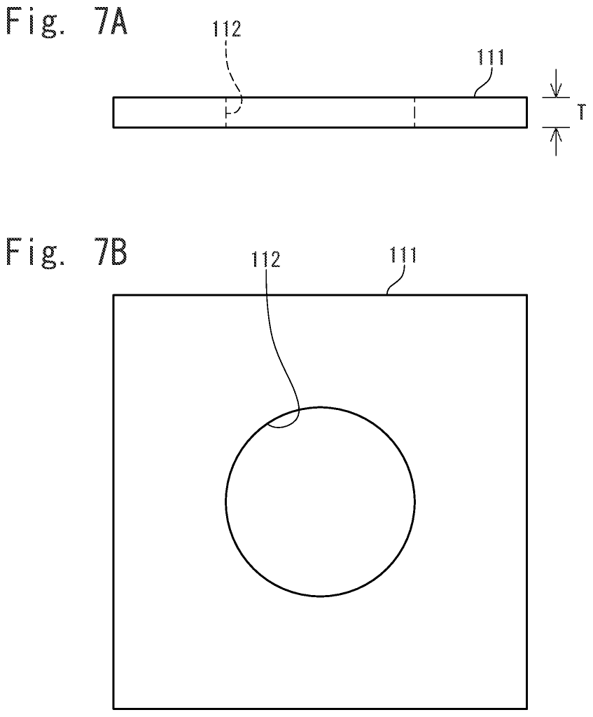

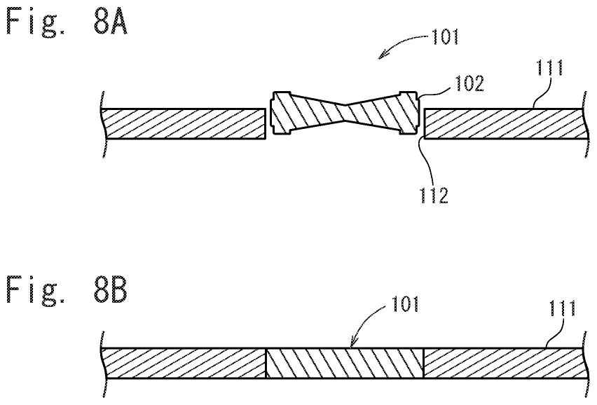

FIGS. 7A and 7B are explanatory views illustrating a metal plate to which the element is joined (A is a front view, and B is a plan view);

FIGS. 8A and 8B are explanatory views illustrating a state where the element is joined to the metal plate;

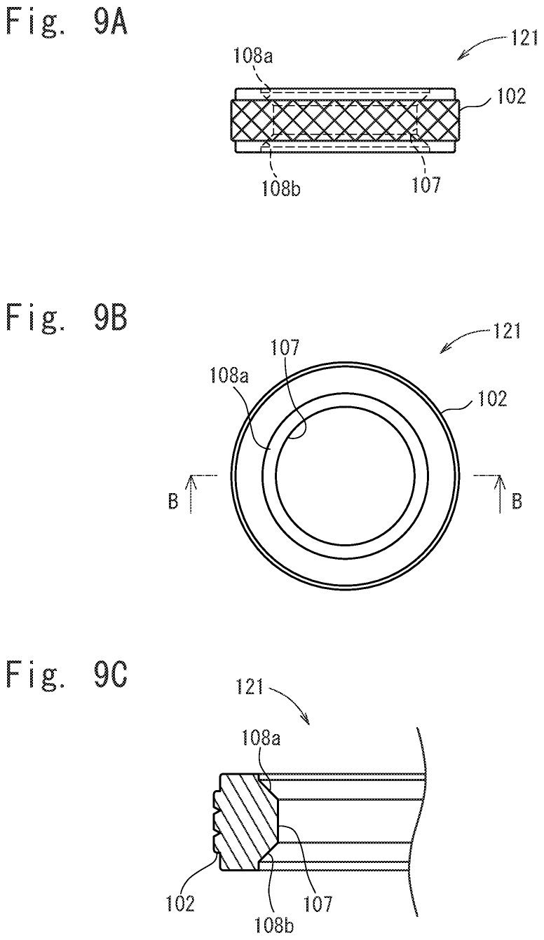

FIGS. 9A to 9C are explanatory views illustrating a modification of the element (A is a front view, B is a plan view, and C is an enlarged view of a part (part on the left side) of a cross-sectional view taken along a line B-B of B); and

FIGS. 10A and 10B are explanatory views illustrating a state where an element is joined to a metal plate by a conventional method.

### Drawings Related to Third Group of Inventions (Claims 9 to 12)

FIG. 11 is an explanatory view illustrating a joined article according to a first embodiment;

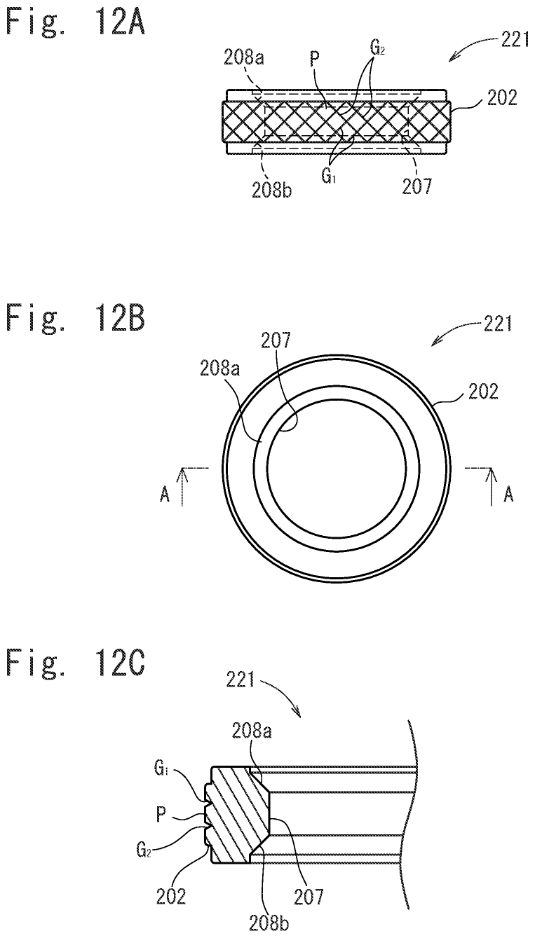

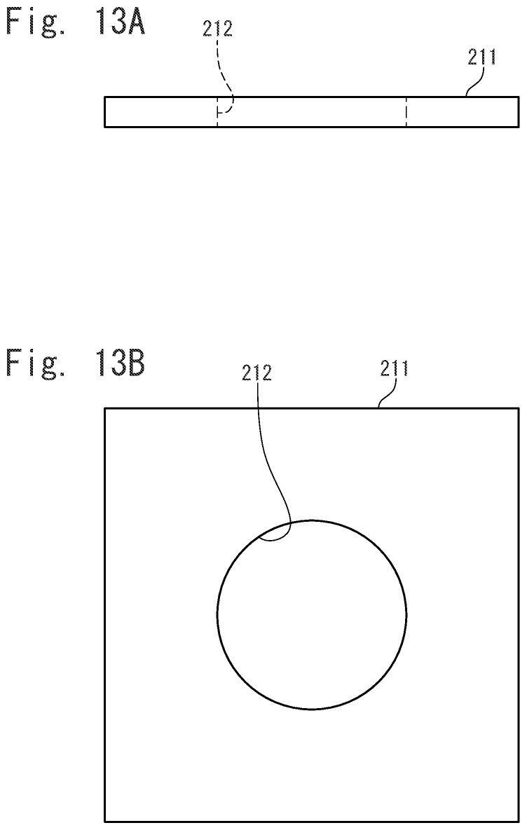

FIGS. 12A to 12C are explanatory views illustrating a metal element (A is a front view, B is a plan view, and C is an enlarged view of a part (part on the left side) of a cross-sectional view taken along a line A-A of B);

FIGS. 13A and 13B are explanatory views illustrating a joint target plate, to which the metal element and a fastening member are assembled (A is a front view, and B is a plan view);

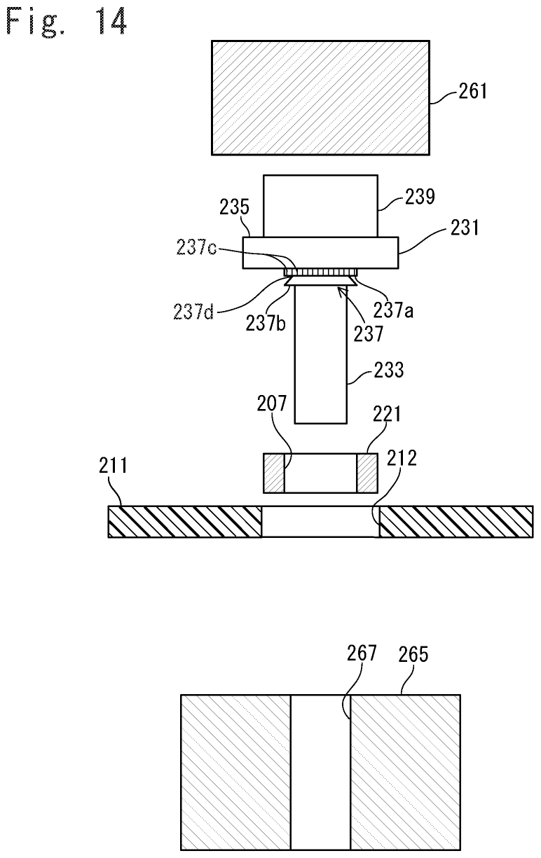

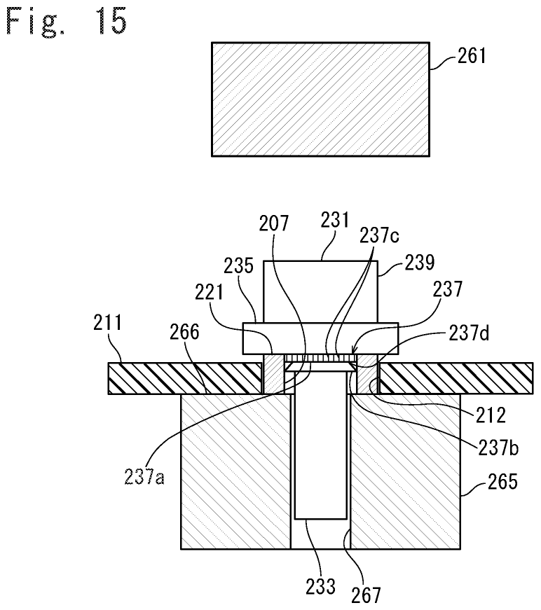

FIG. 14 is an explanatory view of an exemplary preparation process of a manufacturing method for manufacturing the joined article according to the first embodiment, illustrating by an example a state before the metal element and the fastening member are assembled to the joint target plate;

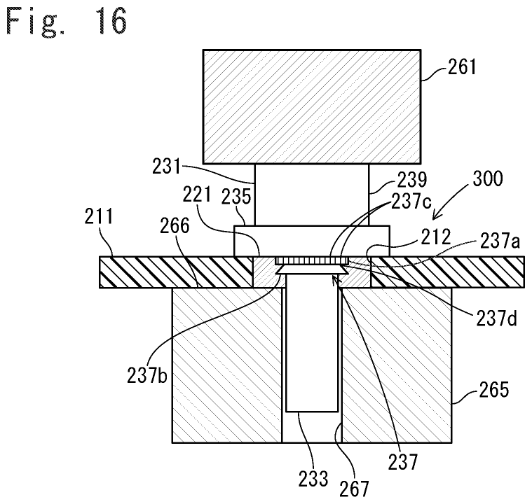

FIG. 15 is an explanatory view of an exemplary arranging process of the manufacturing method for manufacturing the joined article according to the first embodiment, illustrating a state where the joint target plate and the metal element are placed on a lower die and the fastening member is placed on the metal element;

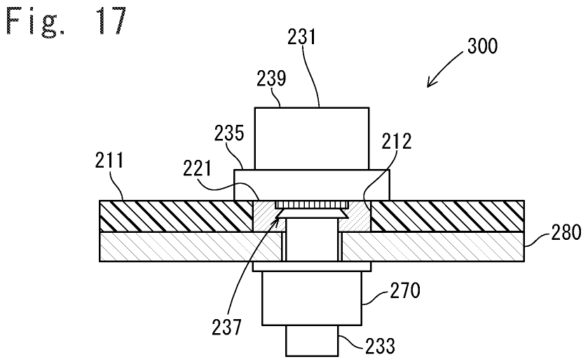

FIG. 16 is an explanatory view of an exemplary pressing process of the manufacturing method for manufacturing the joined article according to the first embodiment, illustrating a state where the fastening member is pressed to the lower side in an axial direction by an upper die after being arranged as illustrated in FIGS. 5A and 5B;

FIG. 17 is an explanatory view illustrating a usage example of the joined article of FIG. 11;

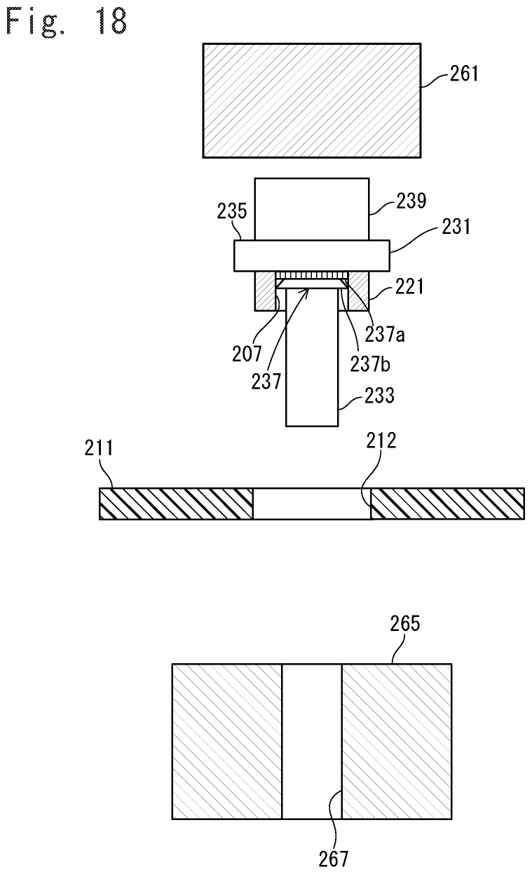

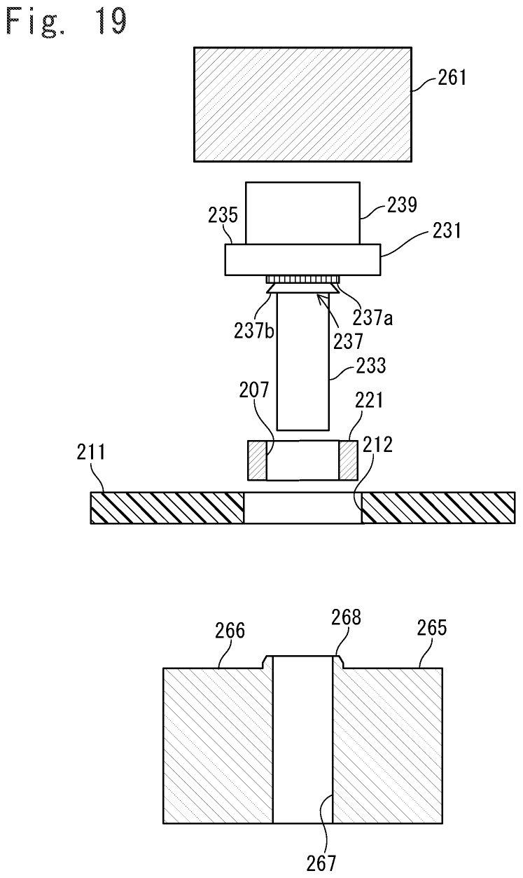

FIG. 18 is an explanatory view describing a modification 1 of the manufacturing method of the joined article;

FIG. 19 is an explanatory view describing a preparation process in a modification 2 of the manufacturing method of the joined article;

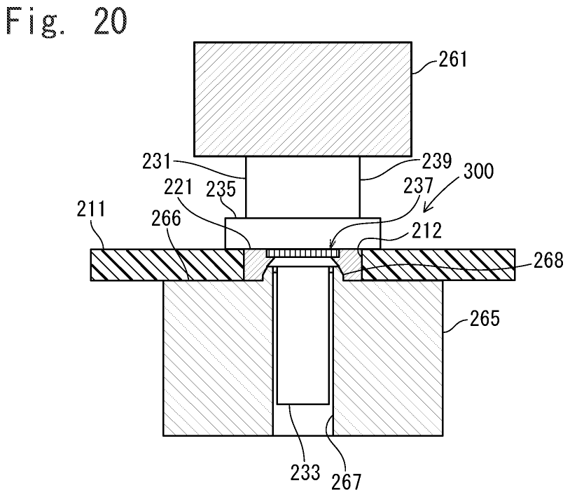

FIG. 20 is an explanatory view describing a pressing process in the modification 2 of the manufacturing method of the joined article;

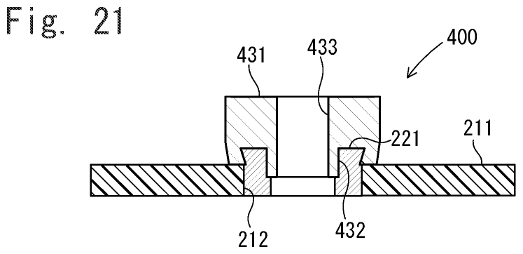

FIG. 21 is an explanatory view illustrating a joined article according to a second embodiment;

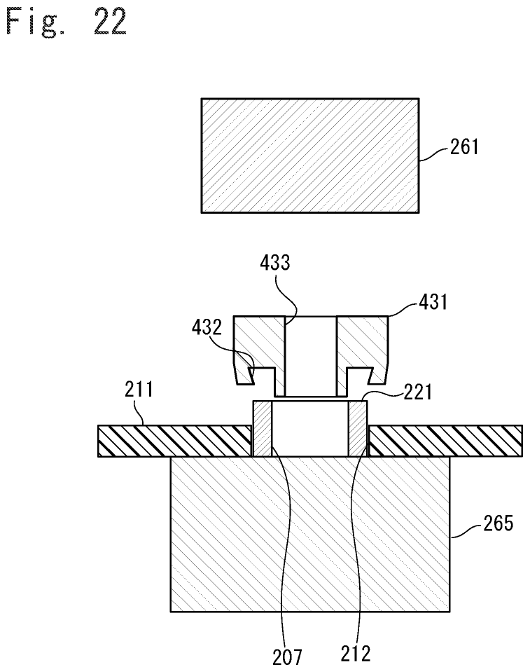

FIG. 22 is an explanatory view of one process of a method for manufacturing the joined article according to the second embodiment, illustrating by an example a state before a fastening member is assembled to a joint target plate;

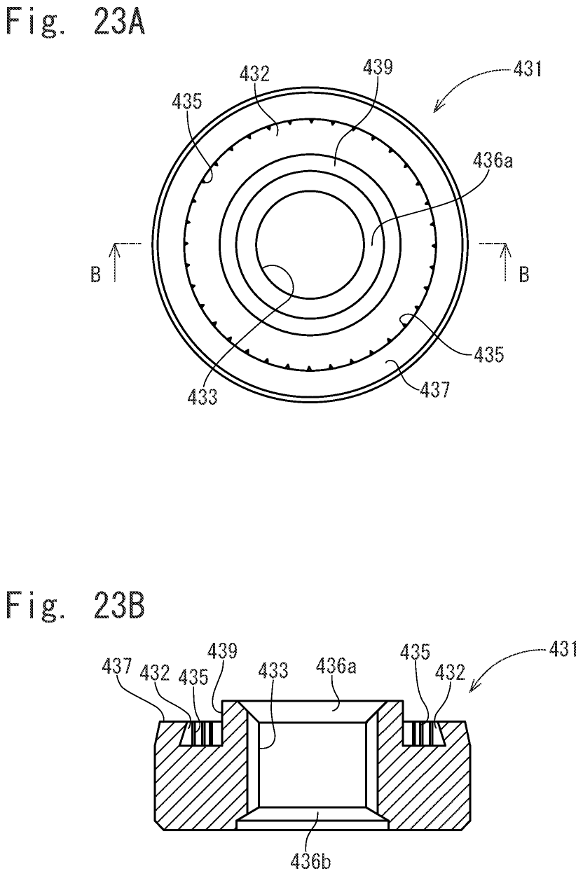

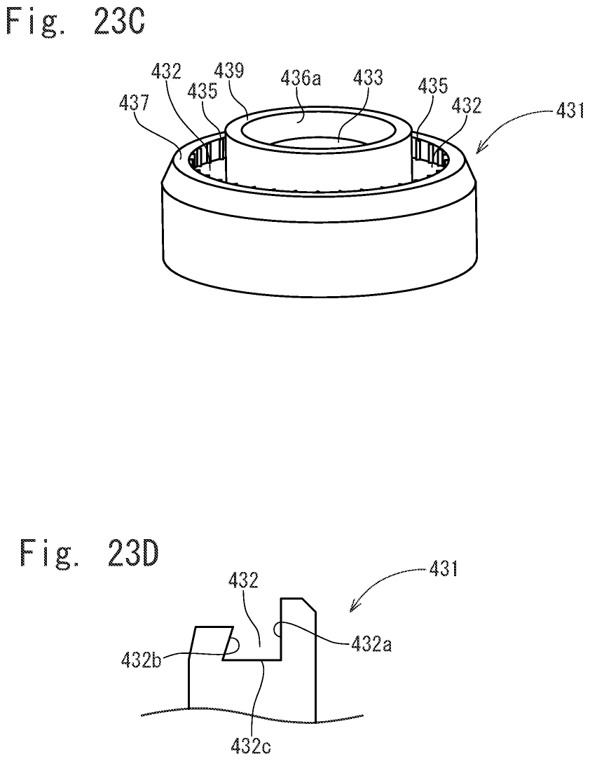

FIGS. 23A to 23D are explanatory views describing a detail of the fastening member used for the joined article according to the second embodiment (A is a plan view, B is a cross-sectional view taken along a line B-B of A, C is a perspective view, and D is an enlarged view simply illustrating an enlarged part of a cross-sectional surface taken along the line B-B of A);

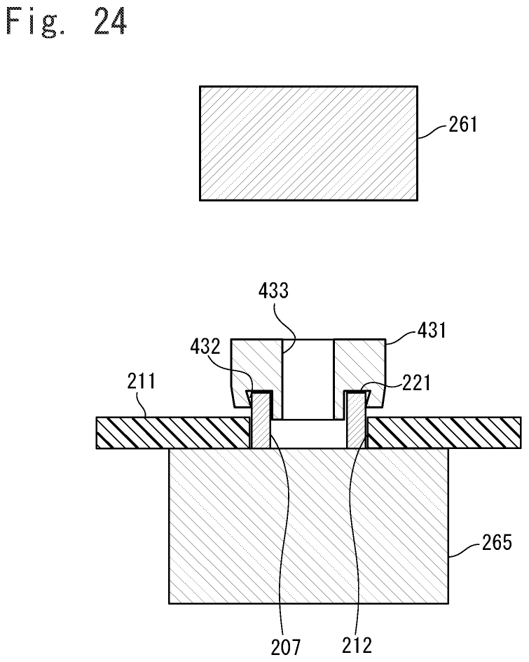

FIG. 24 is an explanatory view of an exemplary arranging process of the manufacturing method of the joined article according to the second embodiment, illustrating a state where the joint target plate and the metal element are placed on the lower die and the fastening member is placed on the metal element;

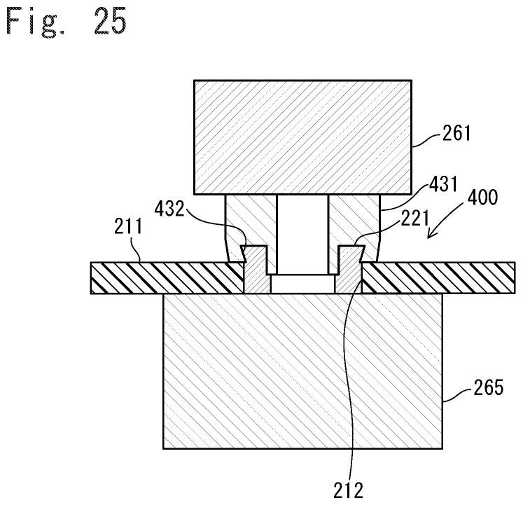

FIG. 25 is an explanatory view of an exemplary pressing process of the manufacturing method of the joined article according to the second embodiment, illustrating a state where the fastening member is pressed to the lower side in the axial direction by the upper die after being arranged as illustrated in FIG. 24;

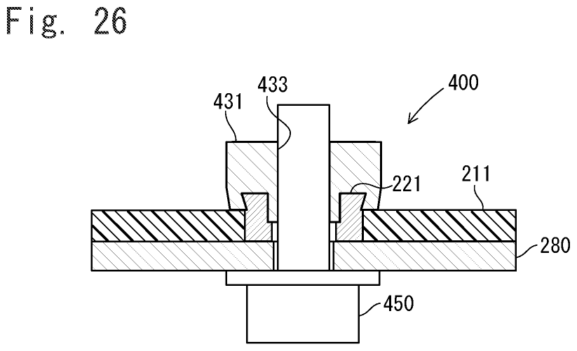

FIG. 26 is an explanatory view illustrating a usage example of the joined article of FIG. 21; and

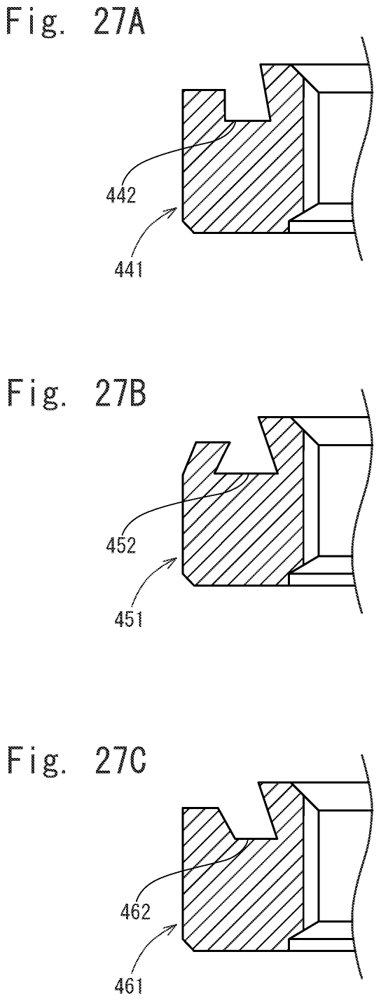

FIGS. 27A to 27C are explanatory views (vertical cross-sectional view of a location where an annular groove is placed) illustrating modifications of the fastening member used for the joined article according to the second embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### Detailed Description of First Group of Inventions (Claims 1 to 4)

The following describes one embodiment of a metal element and a joining structure of an element to a metal plate according to the first group of inventions in the present invention in detail based on the drawings.

### <Structure of Element>

FIGS. 1A to 1C illustrate an element, and an element (rivet) 1 is made of iron (for example, one having a Brinell hardness=approximately 290 HBW) and integrally formed. Then, on the lower side of a flange-shaped part 2 at the top, a columnar part 3 is concentrically formed. The flange-shaped part 2 is formed into an approximately inverted truncated cone shape, which is gradually decreased in diameter from the upper side to the lower side, and has a lower surface that is inclined at approximately 30° with respect to the horizontal surface. An upper surface of the flange-shaped part 2 has a diameter of approximately 11 mm, and the flange-shaped part 2 has a thickness of approximately 0.8 mm. Furthermore, a flat columnar constant diameter portion 4 that has a constant diameter and a thickness of approximately 0.2 mm is formed at an upper end edge of the flange-shaped part 2.

Meanwhile, the columnar part 3 is formed into a flat columnar shape having a diameter=approximately 9.0 mm and a height=1.2 mm. Therefore, the element 1 has a height (H) of approximately 2.0 mm. Then, a depressed-shaped portion 5 having a flat conical shape with a diameter=approximately 8.0 mm and a height (G)=0.35 mm is formed at the center of a lower surface of the columnar part 3. Then, a toric horizontal surface 6 having a constant width (W) is formed at a peripheral area of the depressed-shaped portion 5.

### <Joining Method to Metal Plate Using Element>

FIGS. 2A and 2B illustrate a metal plate to which the element configured as described above is joined, and a metal plate 11 is made of aluminum alloy (for example, one having a Brinell hardness=approximately 50 HBW) and formed into a rectangular flat plate shape having a thickness (T)=1.6 mm. Then, a flat columnar insertion hole 12 having a diameter of approximately 10.0 mm is drilled at an approximate center.

When the element 1 is joined to the above-described metal plate 11, as illustrated in FIG. 3A, the element 1 is inserted into an inside of the insertion hole 12 of the metal plate 11 so that the columnar part 3 is positioned on the lower side. Then, in that state, using a press device (not illustrated), a predetermined pressure (for example, approximately 130 kN) is applied to the element 1 along an axial direction (vertical direction in FIGS. 3A and 3B) to compress the element 1 until the height of the element 1 becomes same as the thickness of the metal plate 11.

By thus applying the predetermined pressure to the element 1, as illustrated in FIG. 3B, a part at a lower end edge of the columnar part 3 of the element 1 deforms to expand in diameter. Meanwhile, at an upper portion of the element 1, a peripheral part at an upper end edge of the insertion hole 12 of the metal plate 11 plastically deforms so as to be pressed down by the flange-shaped part 2, and a gap (S), which exists before the application of pressure, between the columnar part 3 and a peripheral surface of the insertion hole 12 is filled. Then, by thus filling a gap at an upper portion of the part at the lower end edge of the columnar part 3 that has expanded in diameter with a plastically deformed metal, the element 1 enters a state of being rigidly joined to the metal plate 11.

### <Effects of Element>

As described above, the element 1 includes the flange-shaped part 2 and the columnar part 3 having a smaller diameter than the flange-shaped part 2. In a state where the columnar part 3 is inserted into the insertion hole 12 drilled in the metal plate 11, by applying pressure in the axial direction and deforming the part at the distal end edge of the columnar part 3 to expand in diameter, the element 1 is joined to the metal plate 11. Therefore, with the element 1, the columnar part 3 that has plastically deformed to expand in diameter by the pressure in the axial direction is fitted to a shape of the metal plate 11 after plastic deformation. Accordingly, the element 1 can be rigidly joined to the metal plate 11 without providing a retaining shape that expands in diameter to a cylindrical tubular portion in advance (that is, the element 1 can be rigidly joined to the metal plate 11 without providing difficult machining to make a shape that expands in diameter in manufacturing the element 1, therefore facilitating the manufacturing of the element 1).

Moreover, since the element 1 has the depressed-shaped portion 5 formed on a distal end surface of the columnar part 3, a distal end part of the columnar part 3 easily deforms to expand in diameter when pressure is applied in the axial direction. Accordingly, the element 1 is further easily fitted to the shape of the metal plate 11 after plastic deformation and, therefore, can be joined to the metal plate 11 further rigidly.

Furthermore, the element 1 has the flange-shaped part 2 formed into an inverted truncated cone shape and easily enters the insertion hole 12 of the metal plate 11. By allowing the element 1 to have a minimal volume necessary to promote a metal object to plastically deform, the element 1 can be deformed easily by a small pressure so as to have the same thickness as the metal plate 11 (that is, such that both front and back surfaces are flush with the metal plate 11).

Meanwhile, with the above-described joining structure to the metal plate 11 using the element 1, the element 1 is fitted to the shape of the metal plate 11 after plastic deformation by causing the columnar part 3 of the element 1 to plastically deform by the pressure in the axial direction. Accordingly, the element 1 can be rigidly joined to the metal plate 11 without providing difficult machining to add a retaining shape that expands in diameter to the cylindrical tubular portion in advance (such as, in manufacturing the element 1) (that is, the element 1 can be rigidly joined to the metal plate 11 without providing difficult machining to make a shape that expands in diameter in manufacturing the element 1, therefore facilitating the manufacturing of the element 1).

### <Modification of Element and Joining Structure of Element to Metal Plate>

The element according to the first group of inventions (claims 1 to 4) in the present invention is not limited to the aspect of the above-described embodiment at all, and the configuration of material, shape, structure, size, or the like of the flange-shaped part and the columnar part can be appropriately changed as necessary without departing from the gist of the first group of inventions.

For example, the element according to the first group of inventions is not limited to the flat columnar one having the flange-shaped part at the upper end edge as described in the above embodiment, and may be, as illustrated in FIGS. 4A to 4C, for example, a flat and thick-walled cylindrical one in which a through hole 7 that passes through a flange-shaped part and a columnar portion is provided at the axial center. Thus, when the flat and thick-walled cylindrical body in which the through hole 7 is provided at the axial center is employed as the element, as illustrated in FIGS. 4A to 4C, a tapered surface 8 can be disposed around the through hole 7 on the lower surface so as to gradually increase in diameter from the inside to the outside. Thus, by providing the through hole 7 and disposing the tapered surface 8, an element 1′ becomes one in which the lower end edge of the columnar part 3 is easily deformed to expand in diameter by a smaller pressure.

Moreover, the element according to the first group of inventions is not limited to the one in which the flange-shaped part has an inverted truncated cone shape as described in the above embodiment and may be, for example, one in which the flange-shaped part has a flat columnar shape. Furthermore, the element according to the first group of inventions is not limited to the one in which the depressed-shaped portion having a conical shape is formed on the lower surface of the columnar part as described in the above embodiment and may be, for example, one in which a depressed-shaped portion having a shape constituting a part of a spherical body (watch glass shape) is formed or one in which the lower surface of the columnar part is flat.

Meanwhile, the joining structure of an element to a metal plate according to the first group of inventions is not limited to the one in which the element is made of iron (iron steel) and the metal plate is made of aluminum alloy as described in the above embodiment. As long as a metal plate and a metal element that have plastic deformation properties are joined, the types of metals constituting the element and the metal plate can be appropriately changed as necessary. For example, the element may be made of stainless steel (martensitic stainless steel, Vickers hardness=approximately 615), and the metal plate may be made of nickel alloy (Inconel, Vickers hardness=approximately 215).

Meanwhile, the joining structure of an element to a metal plate according to the first group of inventions is not limited to the one in which the gap between the outer periphery of the columnar part of the element and the insertion hole of the metal plate is approximately 1.0 mm as described in the above embodiment. The gap can be appropriately changed roughly in a range of 5% to 15% of the diameter of the element according to the needs, such as the height of the element, the thickness of the metal plate, and the materials of the element and the metal plate. Moreover, in the joining structure of an element to a metal plate according to the first group of inventions, the volume of the element and the volume of a void part of the insertion hole of the metal plate can be preliminarily calculated to become approximately equal, and based on the calculation result, the size of a flange-shaped part, the size of the columnar part, the gap between the outer periphery of the columnar part of the element and the insertion hole of the metal plate, and the volume of the depressed-shaped portion can be determined.

### Detailed Description of Second Group of Inventions (Claims 5 to 8)

The following describes one embodiment of a metal element and a joining structure of an element to a resin plate or metal plate according to the second group of inventions in the present invention in detail based on the drawings.

### <Structure of Element>

FIGS. 6A to 6D illustrate an element, and an element (rivet) 101 is made of iron (for example, one having a Brinell hardness=approximately 290 HBW) and integrally formed into a flat columnar shape having a diameter=approximately 9.0 mm and a height=3.0 mm. In addition, on the surface of an outer periphery, a large-diameter portion (diameter=approximately 9.5 mmφ) 102 having a constant vertical width is formed, and the large-diameter portion 102 has a surface on which diamond-pattern unevenness is formed. That is, on the surface of the large-diameter portion 102, a plurality of inclined grooves G₁, G₁ . . . are engraved in parallel at predetermined intervals, and a plurality of inclined grooves G₂, G₂ . . . are engraved in parallel at predetermined intervals so as to be perpendicular to the grooves G₁, G₁ . . . . Then, protrusions P, P . . . having an approximately truncated square pyramid shape are formed in parts enclosed by the grooves G₁, G₁ . . . and the grooves G₂, G₂ . . . .

Additionally, depressed-shaped portions 103a, 103b constituted of a cylindrical tubular portion having a predetermined depth (approximately 0.3 mm) and a conical portion are formed on an upper surface (front surface) and a lower surface (back surface) of the element 101. The depressed-shaped portions 103a, 103b are arranged symmetrically in the vertical direction. A part at an upper end edge of the depressed-shaped portion 103a on the upper side and a part at a lower end edge of the depressed-shaped portion 103b on the lower side have a columnar shape with a constant diameter (approximately 7.0 mmφ).

### <Joining Method to Resin Plate or Metal Plate Using Element>

The following describes a method for joining the above-described element 101 to a metal plate. FIGS. 7A and 7B illustrate a metal plate to which the element 101 configured as described above is joined, and a metal plate 111 is made of aluminum alloy (for example, one having a Brinell hardness=approximately 50 HBW) and formed into a rectangular flat plate shape having a thickness (T)=1.6 mm. Then, a flat columnar insertion hole 112 having a diameter of approximately 10.0 mm is drilled at an approximate center.

When the element 101 is joined to the above-described metal plate 111, as illustrated in FIG. 8A, the element 101 is inserted into an inside of the insertion hole 112 of the metal plate 111. Then, in that state, using a press device (not illustrated), a predetermined pressure (for example, approximately 60 kN) is applied to the element 101 along the axial direction (vertical direction in FIGS. 8A and 8B) to compress the element 101 until the height of the element 101 becomes same as the thickness of the metal plate 111.

By thus applying the predetermined pressure to the element 101, as illustrated in FIG. 8B, the columnar element 101 deforms to expand in diameter. Then, when the element 101 thus deforms to expand in diameter, the protrusions P, P . . . formed on the outer periphery of the large-diameter portion 102 of the element 101 dig into an inner peripheral surface of the insertion hole 112 of the metal plate 111, and a plastically deformed part of the metal plate 111 enters insides of the grooves G₁, G₁ . . . and the grooves G₂, G₂ . . . . Then, thus, a gap between the outer periphery of the element 101 and the insertion hole 112 of the metal plate 111 is filled by the element 101 that has expanded in diameter. In addition, the protrusions P, P . . . of the large-diameter portion 102 dig into the plastically deformed part of the metal plate 111, and the plastically deformed part of the metal plate 111 enters the insides of the grooves G₁, G₁ . . . and the grooves G₂, G₂ . . . . Consequently, the element 101 enters a state of being rigidly joined to the metal plate 111.

### <Effects of Element>

As described above, the element 101 is formed into a columnar shape in whole and has a surface of the outer periphery in a non-flat shape. In a state where the element 101 is inserted into the insertion hole 112 drilled in the metal plate (or resin plate) 111, by applying pressure in the axial direction to expand a diameter of the element 101 and bringing the part that has expanded in diameter into pressure contact with only the inner surface of the insertion hole 112 of the metal plate 111, the element 101 is joined to the metal plate 111. Therefore, the element 101 can be joined to the metal plate 111 very rigidly.

In addition, the outer peripheral surface of the element 101 has a non-flat shape. Accordingly, when the element 101 plastically deforms by the pressure in the axial direction, the protrusion-shaped part (protrusions P, P . . . ) on the outer peripheral surface digs into the metal plate 111, and the plastically deformed metal plate 111 digs into the depressed-shaped part (grooves G₁, G₁ . . . and grooves G₂, G₂ . . . ) on the outer peripheral surface. Therefore, the element 101 can be joined to the metal plate 111 very rigidly.

Furthermore, in the element 101, the outer peripheral surface of the large-diameter portion 102 is provided by diamond-pattern uneven processing (that is, one having multiple protrusions P, P . . . ). Accordingly, over a wide area on the outer peripheral surface, the protrusions (protrusion-shaped part) P, P . . . dig into the metal plate 111, and the plastically deformed metal plate 111 digs into the grooves G₁, G₁ . . . and grooves G₂, G₂ . . . (depressed-shaped part). Therefore, the element 101 can be joined to the metal plate 111 extremely rigidly.

Moreover, the element 101 is formed into a columnar shape in whole and has both front and back (upper and lower) surfaces formed into a depressed shape. Accordingly, since a load is dispersed to the depressed-shaped parts (thin-walled part in a diametrical direction) when pressure is applied in the axial direction, the load for expanding the diameter can be reduced. Further, since a compression ratio of the element 101 itself can be enhanced, joining to a thin plate (resin plate or metal plate) becomes possible.

Meanwhile, with the above-described joining structure to the metal plate (or resin plate) 111 using the element 101, the element 101 is fitted to the shape of the metal plate 111 after plastic deformation by causing the columnar element 101 to plastically deform by the pressure in the axial direction. Accordingly, the element 101 can be rigidly joined to the metal plate 111 without providing difficult machining to add a retaining shape (shape that expands in diameter) such as a truncated cone-shaped part 153 in FIGS. 10A and 10B to the outer periphery in advance (such as, in manufacturing the element 101) (that is, the element 101 can be rigidly joined to the metal plate 111 without providing difficult machining to make a retaining shape such as the truncated cone-shaped part 153 in FIGS. 10A and 10B in manufacturing the element 101, therefore facilitating the manufacturing of the element 101).

### <Modification of Element and Joining Structure of Element to Resin Plate or Metal Plate>

The element according to the second group of inventions (claims 5 to 8) in the present invention is not limited to the aspect of the above-described embodiment at all, and the configuration of material, shape, structure, size, or the like can be appropriately changed as necessary without departing from the gist of the second group of inventions.

For example, the element according to the second group of inventions is not limited to the one having a columnar shape in whole as described in the above embodiment and may be one having a columnar shape in part. Further, the element according to the second group of inventions may be a flat and thick-walled cylindrical one in which a through hole 107 is provided at the axial center (that is, a hollow one) as illustrated in FIGS. 9A to 9C. Thus, when the through hole 107 is provided, an element 121 becomes one that is easily deformed to expand in diameter by a smaller pressure. Note that when the through hole 107 is thus provided, tapered surfaces 108a, 108b can be formed at end edges of an upper portion and/or a lower portion of the through hole 107 as illustrated in FIGS. 9A to 9C. In addition, when the tapered surfaces 108a, 108b are thus formed, parts at the end edges of the tapered surfaces 108a, 108b can be formed into a columnar shape having a constant diameter.

Moreover, the element according to the second group of inventions is not limited to the one having both front and back (upper and lower) surfaces formed into a depressed shape as described in the above embodiment and may be one in which one of the front surface (upper surface) or the back surface (lower surface) is formed into a depressed shape. Furthermore, the element according to the second group of inventions is not limited to the one in which the depressed-shaped portion having a conical shape or inverted conical shape is formed on both front and back (upper and lower) surfaces of the columnar part as described in the above embodiment. The element may be, for example, one in which a depressed-shaped portion having a shape constituting a part of a spherical body (watch glass shape) is formed on the front surface (upper surface) and/or the back surface (lower surface) of the columnar part.

Furthermore, the element according to the second group of inventions is not limited to the one in which the parts enclosed by the grooves and the grooves are the protrusions having an approximately truncated square pyramid shape in the diamond-pattern processed part on the surface of the columnar body as described in the above embodiment. The element may be, for example, one in which distal ends of protrusions P₂ enclosed by the grooves G₁, G₁ . . . and the grooves G₂, G₂ . . . have a conical shape or curved surface shape (curved surface shape that is a part of a cylindrical body having a predetermined diameter from the axial center).

In addition, the element according to the second group of inventions is not limited to the one in which the surface of the columnar large-diameter portion is provided by diamond-pattern uneven processing as described in the above embodiment. The element may be, for example, one in which protrusions P₃, P₃ . . . having various shapes, such as conical shape, truncated cone shape, pyramid shape, truncated pyramid shape, columnar shape, prismatic shape, and rectangular parallelepiped shape, are formed on the surface of the columnar part in a scattered point pattern or may be, for example, one in which a single or a plurality of circumferential grooves (a serially continuous groove or grooves divided into a plurality of parts in a circumferential direction) G₃, G₃ . . . and a single or a plurality of vertical grooves (a serially continuous groove or grooves divided into a plurality of parts) G₄, G₄ . . . are formed.

Meanwhile, the joining structure of an element to a resin plate or metal plate according to the second group of inventions is not limited to the one in which the element is made of iron (iron steel) and the metal plate is made of aluminum alloy as described in the above embodiment. As long as a resin plate or metal plate and a metal element that have plastic deformation properties are joined, the types of materials constituting the element and the resin plate or metal plate can be appropriately changed as necessary. For example, the element may be made of stainless steel (martensitic stainless steel, Vickers hardness=approximately 615), and the metal plate may be made of nickel alloy (Inconel, Vickers hardness=approximately 215). Alternatively, the element may be made of iron steel, and the resin plate may be made of polypropylene, polyamide, or CFRP.

The joining structure of an element to a resin plate or metal plate according to the second group of inventions is not limited to the one in which the gap between the outer periphery of the columnar part of the element and the insertion hole of the resin plate or metal plate is approximately 1.0 mm as described in the above embodiment. The gap can be appropriately changed roughly in a range of 5% to 15% of the diameter of the element according to the needs, such as the height of the element and the thickness of the resin plate or metal plate, and the materials of the element and the resin plate or metal plate. Moreover, in the joining structure of an element to a resin plate or metal plate according to the second group of inventions, the volume of the element and the volume of a void part of the insertion hole of the resin plate or metal plate can be preliminarily calculated to become approximately equal, and based on the calculation result, the size of the columnar part, the gap between the outer periphery of the columnar part of the element and the insertion hole of the resin plate or metal plate, and the volume of the front and back (upper and lower) depressed-shaped portions can be determined.

### Detailed Description of Third Group of Inventions (Claims 9 to 12)

### First Embodiment

1-1. Joined Article

A joined article 300 illustrated in FIG. 11 is one into which a joint target plate 211 including an insertion hole, an annular metal element 221, and a fastening member 231 are integrated. The joint target plate 211 is a resin plate or metal plate. The metal element 221 is an annular metal object. The fastening member 231 is a member to be secured to the joint target plate 211 and may be a member having a thread groove or a member without having a thread groove. In the joined article 300, in a state where the metal element 221 is inserted through an insertion hole 212 of the joint target plate 211 and in a state where the fastening member 231 is inserted through the metal element 221 as illustrated in FIG. 15 described below, the metal element 221 is compressed to increase an outer diameter and decrease an inner diameter of the metal element 221 as illustrated in FIG. 16. Consequently, the metal element 221 is joined to an inner surface of the insertion hole 212 and coupled to the fastening member 231. Details of a manufacturing method will be described later.

In the example of FIG. 11, the fastening member 231 is configured as a bolt that includes a head portion 239, a shaft portion 233, a flange portion 235, a retaining portion 237, and the like. The fastening member 231 may be a bolt that includes a flat head portion, may be a bolt that includes a hexagonal head portion, or may be another bolt, screw member, pin (for example, a pin that does not have a threaded portion), or the like. The retaining portion 237 is not limited to the structure as illustrated in FIG. 11 and may be substituted with a screw or an incomplete threaded portion. Further, while the retaining portion 237 has both a rotation locking function and a retaining function described below in the example of FIG. 11, the retaining portion 237 need not have a rotation locking function. For example, the retaining portion 237 may be coupled in “a state where the fastening member 231 rotates without dropping off” by a threaded portion and the like. In the example of FIG. 11, the fastening member 231 is a hexagon bolt constituted of a known metallic material. The material of the fastening member 231 is preferably a harder material than the metal element 221.

In FIGS. 12A to 12C, a representative example of the metal element 221 used for the joined article 300 is illustrated. The form illustrated in FIGS. 12A to 12C is an initial form before the metal element 221 plastically deforms by compression. The metal element 221 illustrated in FIGS. 12A to 12C is constituted of, for example, iron (specifically, for example, one having a Brinell hardness=approximately 290 HBW). The metal element 221 has a flat and thick-walled cylindrical configuration in which a through hole 207 is provided at the axial center (that is, a hollow configuration). In the example of FIGS. 12A to 12C, tapered surfaces 208a, 208b are formed at end edges of an upper portion and a lower portion of the through hole 207. In the example of FIGS. 12A to 12C, on the surface of an outer periphery of the metal element 221, a large-diameter portion 202 having a constant vertical width is formed, and the large-diameter portion 202 has a surface on which diamond-pattern unevenness is formed. That is, on the surface of the large-diameter portion 202, the plurality of inclined grooves G₁, G₁ are engraved in parallel at predetermined intervals, and the plurality of inclined grooves G₂, G₂ . . . are engraved in parallel at predetermined intervals so as to be perpendicular to the grooves G₁, G₁ . . . . Then, the protrusions P, P having an approximately truncated square pyramid shape are formed in parts enclosed by the grooves G₁, G₁ and the grooves G₂, G₂ . . . . While the metal element 221 is constituted of iron in the representative example, the metal element 221 may be made of another metallic material, such as low-carbon steel and aluminum.

In FIGS. 13A and 13B, a representative example of the joint target plate 211 is illustrated. The joint target plate 211 illustrated in FIGS. 13A and 13B is a resin plate configured to be in a plate shape having a predetermined thickness only using a known resin material or mainly using a known resin material. The joint target plate 211 of the representative example is constituted of, for example, a resin material and has a rectangular flat plate shape having a predetermined thickness. The insertion hole 212 is formed at an approximate center of the joint target plate 211. The insertion hole 212 has an inner diameter larger than an outer diameter in the initial form of the metal element 221 and has a circular shape in planar view. The insertion hole 212 is provided in a configuration that passes through the joint target plate 211 in a thickness direction so as to reach from one plate surface of the joint target plate 211 to the other plate surface. When the joint target plate 211 is configured as a resin plate, the resin material constituting the resin plate may be a carbon fiber composite resin material, such as CFRP and CFRTP, or may be a nylon-based resin.

1-2. Manufacturing Method of Joined Article

The following description relates to the manufacturing method for manufacturing the joined article 300 as illustrated in FIG. 11. In the manufacturing method, the fastening member 231 is assembled to the above-described joint target plate 211 using the metal element 221 to form the joined article 300.

In the manufacturing method, as illustrated in FIG. 14, the above-described fastening member 231, the metal element 221, and the joint target plate 211 are prepared. In FIG. 14, a configuration of the fastening member 231 viewed from the front is conceptually illustrated. A cut cross-sectional surface of the metal element 221 illustrated in FIGS. 12A to 12C, which is cut off in the thickness direction at the axial center position, is simply illustrated. A cut surface of the joint target plate 211 illustrated in FIGS. 13A and 13B, which is cut off in the thickness direction at the center position of the insertion hole 212, is simply illustrated.

After the fastening member 231, the metal element 221, and the joint target plate 211 are prepared as illustrated in FIG. 14, the metal element 221 is inserted into an inside of the insertion hole 212 of the joint target plate 211 as illustrated in FIG. 15. Furthermore, the shaft portion 233 of the fastening member 231 is inserted into an inside of the through hole 207 of the metal element 221. In the example of FIG. 15, on an upper surface 266 of a lower die 265 of a press device, the metal element 221 is placed around an upper end opening portion of a hole portion 267, and the joint target plate 211 is placed around the metal element 221. Then, the through hole 207 of the metal element 221 is communicated with the hole portion 267 of the lower die 265, and arrangement is performed in a configuration in which the shaft portion 233 is inserted into the through hole 207 and the hole portion 267 and a configuration in which the retaining portion 237 of the fastening member 231 is placed on the metal element 221. The retaining portion 237 is a part having a function to be fastened to the metal element 221 so that the shaft portion 233 does not fall out of the metal element 221 (retaining function) when the fastening member 231 is coupled as illustrated in FIG. 16. Furthermore, the retaining portion 237 also has a function to be fastened to the metal element 221 so that the fastening member 231 does not to rotate with respect to the metal element 221 (rotation locking function) when fastening member 231 is coupled as illustrated in FIG. 16. In the example of FIG. 15, the retaining portion 237 has an anti-rotation portion 237a and a coming-off prevention portion 237b. The anti-rotation portion 237a is configured to have a columnar shape having a low height and configured to have a stepped shape in a form that protrudes from a surface on the shaft portion 233 side of the flange portion 235. The anti-rotation portion 237a has an outer peripheral surface where a plurality of grooves 237c are formed in a form divided in the circumferential direction, and the surface of the outer peripheral surface forms an uneven shape. Each of the grooves 237c extends in approximately parallel to the axial direction of the shaft portion 233. In the coupling state of FIG. 16, a part of the metal element 221 enters each groove of the plurality of grooves 237c, and such a fastening state ensures rotation locking of the fastening member 231 against the metal element 221. The coming-off prevention portion 237b is arranged between the anti-rotation portion 237a and the shaft portion 233. The coming-off prevention portion 237b has an outer peripheral surface that increases in diameter as approaching the shaft portion 233 side. The retaining portion 237 has a groove 237d in the circumferential direction configured by a surface on the shaft portion 233 side of the anti-rotation portion 237a and the outer peripheral surface (tapered surface) of the coming-off prevention portion 237b. In the coupling state of FIG. 16, a part of the metal element 221 enters a groove of the groove 237d in the circumferential direction, and such a fastening state as the metal element 221 is hooked on the groove 237d in the circumferential direction ensures retaining of the fastening member 231 with respect to the metal element 221.

In the arrangement state of FIG. 15, an inner peripheral surface of the metal element 221 is arranged on the outer side of the shaft portion 233, and an inner peripheral surface of the insertion hole 212 is arranged on the outer side of the metal element 221. In the arrangement state, an upper die 261 moves down and acts to press an upper end of the fastening member 231 to the lower side in the axial direction at a predetermined pressure (for example, approximately 60 kN). In the arrangement state, the thickness direction of the joint target plate 211 and the thickness direction of the metal element 221 are the vertical direction, and the axial direction of the fastening member 231 (a direction in which the shaft portion 233 extends) is also the vertical direction. When the upper die 261 presses the fastening member 231 to the lower side, in the fastening member 231 that receives the pressing force, the force to attempt to move in a downward direction increases, and the flange portion 235 and the retaining portion 237 of the fastening member 231 act to strongly press the upper end of the metal element 221 to the lower side in the axial direction. Then, the metal element 221 arranged between the shaft portion 233 and the insertion hole 212 is compressed in the thickness direction. That is, in the state where the metal element 221 is inserted through the insertion hole 212 and in the state where the shaft portion 233 of the fastening member 231 is inserted through the metal element 221, the metal element 221 is compressed in the thickness direction, and as illustrated in FIG. 16, deformation that increases the outer diameter and deformation that decreases the inner diameter are caused in the metal element 221.

When such deformation is caused in the metal element 221, an outer peripheral surface of the metal element 221 is strongly pressed against the inner surface of the insertion hole 212, and the protrusions P, P . . . formed on an outer periphery of the large-diameter portion 202 of the metal element 221 dig into an inner peripheral surface of the insertion hole 212 of the joint target plate 211, and a plastically deformed part of the joint target plate 211 enters the insides of the grooves G₁, G₁ . . . and the grooves G₂, G₂ . . . . Then, a gap between the outer periphery of the metal element 221 and the insertion hole 212 of the joint target plate 211 is filled by the metal element 221 that has thus expanded in diameter. In addition, the protrusions P, P . . . of the large-diameter portion 202 dig into the plastically deformed part of the joint target plate 211, and the plastically deformed part of the joint target plate 211 enters the insides of the grooves G₁, G₁ . . . and the grooves G₂, G₂ . . . . Consequently, the metal element 221 enters a state of being rigidly joined to the joint target plate 211.

At the time of pressing by the upper die 261, deformation that decreases the inner diameter is also caused in the metal element 221. Specifically, the inner peripheral surface side of the metal element 221 deforms such that the retaining portion 237 is joined by entering an inside of the metal element 221 and the inner peripheral surface of the metal element 221 is joined by being pressed strongly against the outer peripheral surface of the shaft portion 233. More specifically, a part on the inner peripheral surface side of the metal element 221 deforms so as to enter each of the grooves 237c formed on the outer peripheral surface of the anti-rotation portion 237a and also enter the groove 237d in the circumferential direction. Accordingly, the fastening member 231 enters a state of being rigidly joined to the metal element 221 in a form that ensures rotation locking by hooking of each of the grooves 237c and the metal element 221 and ensures retaining by hooking of the groove 237d and the metal element 221. Such a pressing process (process of pressing the fastening member 231 to the lower side in the axial direction by the upper die 261) may be performed, for example, until the height of the metal element 221 becomes same as the thickness of the joint target plate 211. By the manufacturing method, the joined article 300 in which the joint target plate 211, the metal element 221, and the fastening member 231 are integrally joined is obtained.

1-3. Example of Effects

In the joined article 300, the fastening member 231 can be secured utilizing plastic deformation of the metal element 221 by compression. Accordingly, the fastening member 231 can be joined to the joint target plate 211 while the use of a heat source, a solvent adhesive, or the like is reduced or not required. In particular, the above-described joined article 300 has undergone plastic deformation that increases the outer diameter in the metal element 221 in the state where the metal element 221 is inserted through the insertion hole 212. Accordingly, the outer peripheral portion of the metal element 221 easily comes in close contact with the inner peripheral portion of the insertion hole 212 strongly. Even when the use of a heat source, a solvent adhesive, or the like is reduced or not required, joining between the joint target plate 211 and the metal element 221 is easily maintained rigidly. Furthermore, the joined article 300 has undergone plastic deformation that decreases the inner diameter of the metal element 221 in the state where the fastening member 231 is inserted through the metal element 221. Accordingly, the inner peripheral portion of the metal element 221 easily comes in close contact with the fastening member 231 strongly. Even when the use of a heat source, a solvent adhesive, or the like is reduced or not required, coupling between the metal element 221 and the fastening member 231 is easily maintained rigidly.

In the joined article 300, the fastening member 231 having a male thread portion can be integrated with the joint target plate 211 while the use of a heat source, a solvent adhesive, or the like is reduced or not required. In particular, the joined article 300 has a structure in which the inner diameter of the metal element 221 decreases to tighten the shaft portion 233 by the plastic deformation in the state where the shaft portion 233 is inserted through the metal element 221. Accordingly, the metal element 221 can be rigidly joined to the shaft portion 233. Furthermore, the male thread portion can be disposed in a region, which lies out of the metal element 221, in the shaft portion 233 of the fastening member 231, that is, a region that does not contribute to the joining to the metal element 221. Accordingly, the fastening member 231 can be configured integrally with the joint target plate 211, and the male thread portion can be preferably disposed in the integrated object.

When the above-described manufacturing method is used, in the pressing process, the metal element 221 is less likely to expand in the downward direction and is likely to expand in a radial direction centered on the shaft portion 233. Therefore, burrs of the metal element 221 are less likely to occur in the proximity of a plate surface of the joint target plate 211.

The joined article 300 manufactured using the above-described manufacturing method can be used as illustrated in FIG. 17. The example of FIG. 17 is a structure configured to be fastened by inserting the shaft portion 233 into a hole portion formed in a metal plate 280, stacking to arrange the metal plate 280 and the joint target plate 211, and in that state, fastening a nut 270 to the male thread portion formed in the shaft portion 233. Such a use brings a metal touch of the metal element 221 when an object to be fastened (metal plate 280) is fastened, becoming advantageous for fastening.

<Modification 1 of Manufacturing Method of Joined Article>

In the manufacturing method according to the first embodiment, in a preparation process, the metal element 221 and the fastening member 231 are each prepared separately as illustrated in FIG. 14 and brought close to one another to arrange as illustrated in FIG. 15 before the pressing process. However, the manufacturing method is not limited to this example. For example, as illustrated in FIG. 18, the metal element 221 and the fastening member 231 may be maintained in a form in which the fastening member 231 is inserted into the through hole 207 of the metal element 221, and in this state, components may be prepared. Examples of a method for maintaining the metal element 221 and the fastening member 231 in the assembled state include, for example, a method in which an adhesive medium or another means is used to attach the fastening member 231 to the metal element 221, and the metal element 221 and the fastening member 231 are maintained in the state. Note that the manufacturing method of Modification 1 is different from the first embodiment only in a point of managing by attaching the fastening member 231 to the metal element 221 and can be similar to the manufacturing method of the first embodiment other than this point.

<Modification 2 of Manufacturing Method of Joined Article>

While the lower die 265 having the flat upper surface 266 is used in the pressing process in the manufacturing method according to the first embodiment, the lower die 265 may be changed to a lower die 265 as illustrated in FIG. 19. The lower die 265 of FIG. 19 includes an annular projecting portion 268 that annularly projects in the proximity of an upper end opening of the hole portion 267. When the pressing process similar to that of FIG. 16 is performed, as illustrated in FIG. 20, the annular projecting portion 268 enters the insertion hole 212 so as to occupy a part of a space in the insertion hole 212 and is pushed into the metal element 221. Thus, by pushing the annular projecting portion 268 into the metal element 221 so as to occupy a part of the space in the insertion hole 212, the degree of crushing the metal element 221 becomes greater than that in a case where the annular projecting portion 268 does not exist as illustrated in FIG. 16, resulting in a greater decrease of the inner diameter and a greater expansion of the outer diameter of the metal element 221. Therefore, a clinching strength by the metal element 221 can be more enhanced. Note that the manufacturing method of Modification 2 is different from the first embodiment only in a point of providing the annular projecting portion 268 in the lower die 265 to perform the pressing process and can be similar to the manufacturing method of the first embodiment other than this point.

### Second Embodiment

2-1. Joined Article

A joined article 400 illustrated in FIG. 21 is one into which the joint target plate 211 including the insertion hole 212, the annular metal element 221, and a fastening member 431 are integrated. The joint target plate 211 is a resin plate or metal plate. The metal element 221 is an annular metal object. The fastening member 431 is a member to be secured to the joint target plate 211 and may be a member having a thread groove or a member without having a thread groove. In the joined article 400, in a state where the metal element 221 is inserted through the insertion hole 212 of the joint target plate 211 and in a state where the fastening member 431 is inserted through the metal element 221 as illustrated in FIG. 24 described below, the metal element 221 is compressed to increase the outer diameter and decrease the inner diameter of the metal element 221 as illustrated in FIG. 25. Consequently, the metal element 221 is joined to the inner surface of the insertion hole 212 and coupled to the fastening member 431. Details of a manufacturing method will be described later.

When the joined article 400 of FIG. 21 is manufactured, as illustrated in FIG. 22, the joint target plate 211 similar to that of the first embodiment and the metal element 221 similar to that of the first embodiment can be used. As the joint target plate 211 and the metal element 221, those in the representative example of the first embodiment may be applied, or those in various modifications described above or below may be applied.

The fastening member 431 may be a nut having a female thread, may be an annular collar without having a female thread, or may be another annular component. In the example of FIG. 22, an annular groove 432 having a size that allows the metal element 221 to be inserted into is formed on one surface of the annularly configured fastening member 431. The annular groove 432 is disposed around a hole portion 433 of the fastening member 431.

For example, the fastening member 431 used in the example of FIG. 22 is configured as a nut as illustrated in FIGS. 23A to 23D. The fastening member 431 is made of metal (for example, iron) and integrally formed into a flat columnar shape (cylindrical shape) with the columnar hole portion 433 (screw insertion hole) drilled in the center. A screw groove (not illustrated) is threaded on an inner peripheral surface of the hole portion 433, and tapered surfaces 436a, 436b for facilitating threaded engagement with a screw (not illustrated) are formed at upper end edge and a lower end edge of the hole portion 433. A peripheral part on the upper side of the hole portion 433 projects upward with respect to the other part, and forms a cylindrical tubular portion 439 having a constant thickness. Then, on an outer periphery on the lower side of the cylindrical tubular portion 439, the annular groove 432 having a vertical cross-section in a dovetail groove shape (groove shape in which the lower part is wider than the upper part) is formed as a circumferential void portion. The annular groove 432 has a vertical inner wall surface 432a on the inner side, and an inner wall surface 432b inclined at a predetermined angle (for example, about 15°) with respect to the vertical direction (axial direction) (inclined outward from the upper side toward the lower side) on the outer side. Then, a horizontal bottom surface 432c having a constant width is formed between a lower end of the inner wall surface 432a on the inner side and a lower end of the inner wall surface 432b on the outer side. On the inner wall surface 432b on the outer side, a plurality of anti-rotation ribs 435, 435 . . . having horizontal cross-sectional surfaces in a triangular shape are vertically disposed at regular intervals. Each of the anti-rotation ribs 435, 435 . . . projects toward the center side of the hole portion 433. The upper part of an outer peripheral surface of the fastening member 431 is inclined at a predetermined angle with respect to the vertical direction (axial direction) (inclined outward from the upper side toward the lower side), and a part between the inclined surface and the inner wall surface 432b on the outer side of the annular groove 432 forms an outer tubular portion 437.

2-2. Manufacturing Method of Joined Article

The following description relates to the manufacturing method for manufacturing the joined article 400 as illustrated in FIG. 21. In the manufacturing method, the fastening member 431 is assembled to the above-described joint target plate 211 using the metal element 221 to form the joined article 400.

In the manufacturing method, as illustrated in FIG. 22, the fastening member 431, the metal element 221, and the joint target plate 211 are prepared, and the metal element 221 is placed on the lower die 265 so as to be inserted into the inside of the insertion hole 212 of the joint target plate 211. Furthermore, as illustrated in FIG. 24, an end portion of the metal element 221 is inserted into an inside of the annular groove 432 of the fastening member 431. In the example of FIG. 24, the metal element 221 is placed on the lower die 265, the joint target plate 211 is placed around the metal element 221, and the end portion of the metal element 221 is inserted into the inside of the annular groove 432 of the fastening member 431. In that state, the fastening member 431 is placed on the metal element 221.

Then, in the arrangement state as illustrated in FIG. 24, the upper die 261 moves down and acts to press an upper end of the fastening member 431 to the lower side in the axial direction at a predetermined pressure (for example, approximately 60 kN). When the upper die 261 presses the fastening member 431 to the lower side, in the fastening member 431 that receives the pressing force, the force to attempt to move in the downward direction increases, and the vicinity of a lower end portion of the fastening member 431 acts to strongly press the upper end of the metal element 221 to the lower side in the axial direction. Then, in the state where the metal element 221 is inserted through the insertion hole 212 and in a state where a part in the vicinity of the annular groove 432 is inserted into the through hole 207 of the metal element 221, the metal element 221 is compressed in the thickness direction, and as illustrated in FIG. 25, deformation that increases the outer diameter and deformation that decreases the inner diameter are caused in the metal element 221.

When such deformation is caused in the metal element 221, a part of the outer peripheral surface of the metal element 221 is strongly pressed against the inner surface of the insertion hole 212 to enter a state of being rigidly joined to the insertion hole 212, and the other part of the outer peripheral surface of the metal element 221 expands in the annular groove 432 to enter a state of being joined to inner walls of the annular groove 432. More specifically, the outer peripheral surface side of the metal element 221 deforms such that each of the anti-rotation ribs 435, 435 . . . disposed in a projecting form as illustrated in FIGS. 23A to 23D digs into the outer peripheral surface of the metal element 221. Such deformation causes the fastening member 431 to be coupled in a state where rotation locking is ensured by hooking of the anti-rotation ribs 435, 435 . . . and the metal element 221. Furthermore, a part on the outer peripheral surface side of the metal element 221 deforms so as to enter up to the vicinity of a boundary between the inner wall surface 432b and the bottom surface 432c, and a part on the inner peripheral surface side of the metal element 221 deforms so as to decrease the inner diameter in the annular groove 432. Thus, since the metal element 221 deforms so as to be filled in the annular groove 432, the fastening member 431 is coupled in a form where retaining is ensured by hooking of the vicinity of the inner wall surface 432b and the metal element 221. By the manufacturing method, the joined article 400 in which the joint target plate 211, the metal element 221, and the fastening member 431 are integrally joined is obtained.

The joined article 400 manufactured using the above-described manufacturing method can be used as illustrated in FIG. 26. The example of FIG. 26 is a structure configured to be fastened by adjusting the positions of the hole portion formed in the metal plate 280 and the hole portion 433 of the fastening member 431, stacking to arrange the metal plate 280 and the joint target plate 211, and in that state, causing a male thread portion formed in a shaft portion of a bolt 450 to engage with a female thread portion formed in the hole portion 433 of the fastening member 431. Such a use brings a metal touch of the metal element 221 when an object to be fastened (metal plate 280) is fastened, becoming advantageous for fastening.

In the manufacturing method according to the second embodiment, in a preparation process, the metal element 221 and the fastening member 431 are each prepared separately as illustrated in FIG. 22 and brought close to one another to arrange as illustrated in FIG. 24 before the pressing process. However, the manufacturing method is not limited to this example. For example, the metal element 221 and the fastening member 431 may be maintained in a form in which the metal element 221 is inserted into the annular groove 432 of the fastening member 431, and in this state, components may be prepared. Examples of a method for maintaining the metal element 221 and the fastening member 431 in the assembled state include, for example, a method in which an adhesive medium or another means is used to attach the fastening member 431 to the metal element 221 and the metal element 221 and the fastening member 431 are maintained in the state.

### Other Embodiments

The third group of inventions (claims 9 to 12) in the present invention is not limited to the embodiments described by the above description and drawings. For example, the features of the embodiments described above or below can be combined in every form provided no contradiction arises therebetween. Any of the features of the embodiments described above or below can be omitted unless it is clearly specified as being essential. Furthermore, the above-described embodiments may be changed as follows.

In the above-described embodiments, the joint target plate 211 is configured as a resin plate. However, the joint target plate 211 may be a metal plate configured only using a metallic material or mainly using a metallic material. When the joint target plate 211 is configured as a metal plate, the metallic material used may be a metallic material that is likely to plastically deform, such as low-carbon steel and aluminum, or may be a metallic material that is less likely to plastically deform, such as high tensile strength steel and magnesium.

In the above-described embodiments, a configuration in which the parts enclosed by the grooves and the grooves are protrusions having an approximately truncated square pyramid shape in the diamond-pattern processed part on the surface of the columnar body is illustrated by an example. However, the third group of inventions is not limited to the configuration, and the distal ends of the protrusions P, P . . . enclosed by the grooves G₁, G₁ . . . and the grooves G₂, G₂ . . . may have a conical shape or curved surface shape (such as, a curved surface shape that is a part of a cylindrical body having a predetermined diameter from the axial center).

In the above-described embodiments, a configuration in which the outer peripheral surface of the metal element 221 is provided by diamond-pattern uneven processing is illustrated by an example. However, protrusions having various shapes, such as conical shape, truncated cone shape, pyramid shape, truncated pyramid shape, columnar shape, prismatic shape, and rectangular parallelepiped shape, may be formed on the outer peripheral surface of the metal element 221 in a scattered point pattern. Alternatively, a single or a plurality of circumferential grooves (a serially continuous groove or grooves divided into a plurality of parts in the circumferential direction) and a single or a plurality of vertical grooves (a serially continuous groove or grooves divided into a plurality of parts) may be formed on the outer peripheral surface of the metal element 221.

In the representative example of the second embodiment, the fastening member 431 as illustrated in FIGS. 23A to 23D is used. However, the third group of inventions is not limited to the example. The fastening member 431 can be changed to, for example, one having an annular groove 442, such as a fastening member 441 illustrated in FIG. 27A, one having an annular groove 452, such as a fastening member 451 illustrated in FIG. 27B, or one having an annular groove 462, such as a fastening member 461 illustrated in FIG. 27C. The annular groove 442 has a dovetail groove shape in which the inner wall surface on the inner side is inclined to narrow downward (that is, a cylindrical tubular portion is gradually decreased in diameter from the upper side to the lower side). The annular groove 452 has a dovetail groove shape in which the inner wall surface on the inner side is inclined to narrow downward (that is, the cylindrical tubular portion is gradually decreased in diameter from the upper side to the lower side) and the inner wall surface on the outer side is inclined to expand downward (inclined to be gradually increased in diameter from the upper side to the lower side). The annular groove 462 has a groove shape in which an inner wall surface on the inner side is inclined to narrow downward (that is, the cylindrical tubular portion is gradually decreased in diameter from the upper side to the lower side) and the inner wall surface on the outer side is inclined to narrow downward (inclined to be gradually decreased in diameter from the upper side to the lower side). In any of the fastening members 441, 451, 461 illustrated in FIGS. 27A to 27C, anti-rotation ribs similar to the anti-rotation ribs 435 disposed in the fastening member 431 of FIGS. 23A to 23D can be disposed to add a rotation locking function. Moreover, in the annular grooves 432, 442, 452, 462 illustrated in FIGS. 23A to 23D and FIGS. 27A to 27C, an uneven structure other than the anti-rotation ribs 435 may be disposed to realize a rotation locking function, or a rotation locking function need not be disposed in the annular grooves 432, 442, 452, 462.

It should be considered that the embodiments disclosed herein are exemplifications in every respect and not limiting. The scope of the present invention is not limited to the embodiments disclosed herein, but rather is intended to include all modifications within the scope indicated by claims or the scope equivalent to the scope of claims.

### INDUSTRIAL APPLICABILITY

### Industrial Applicability of First Group of Inventions (Claims 1 to 4)

The element according to the first group of inventions in the present invention provides the excellent effects as described above, and therefore, can be appropriately used as a member to be joined to a metal plate made of metal having a plastic deformation property. Additionally, the joining structure of an element to a metal plate according to the first group of inventions in the present invention can be appropriately used as a structure for joining dissimilar metals to one another.

### Industrial Applicability of Second Group of Inventions (Claims 5 to 8)

The element according to the second group of inventions in the present invention provides the excellent effects as described above, and therefore, can be appropriately used as a member to be joined to a metal plate made of metal having a plastic deformation property or a resin plate made of synthetic resin that is not as likely to plastically deform as metal. Additionally, the joining structure of an element to a metal plate according to the second group of inventions in the present invention can be appropriately used as a structure for joining resins or dissimilar metals to one another.

### Industrial Applicability of Third Group of Inventions (Claims 9 to 12)

The joined article according to the third group of inventions in the present invention provides the excellent effects as described above, and therefore, can be appropriately used as a member in which a fastening member is rigidly fastened to a metal element. Additionally, the manufacturing method of a joined article according to the third group of inventions in the present invention can be appropriately used as a method for manufacturing a joined article by rigidly fastening a fastening member to a metal element.

### DESCRIPTION OF REFERENCE SIGNS

### Description of Reference Signs Related to First Group of Inventions (Claims 1 to 4)

1, 1′ . . . Element
2 . . . Flange-shaped part
3 . . . Columnar part
5 . . . Depressed-shaped portion
11 . . . Metal plate
12 . . . Insertion hole

### Description of Reference Signs Related to Second Group of Inventions (Claims 5 to 8)

101, 121 . . . Element
102 . . . Large-diameter portion
103a, 103b . . . Depressed-shaped portion
107 . . . Through hole
111 . . . Metal plate
112 . . . Insertion hole
P, P₂, P₃, P₄ . . . Protrusion
G₁, G₂, G₃, G₄ . . . Groove
153 . . . Truncated cone-shaped part (retaining shape of element by conventional method of construction)

### Description of Reference Signs Related to Third Group of Inventions (Claims 9 to 12)

202 . . . Large-diameter portion
207 . . . Through hole
208a . . . Tapered surface
208b . . . Tapered surface
211 . . . Joint target plate (resin plate, metal plate)
212 . . . Insertion hole
221 . . . Metal element
231, 431, 441, 451, 461 . . . Fastening member
233 . . . Shaft portion (male thread portion)
235 . . . Flange portion
237 . . . Retaining portion
237a . . . Anti-rotation portion
237b . . . Coming-off prevention portion
237c . . . Groove
237d . . . Groove
239 . . . Head portion
261 . . . Upper die
265 . . . Lower die
266 . . . Upper surface
267 . . . Hole portion
268 . . . Annular projecting portion
270 . . . Nut
280 . . . Metal plate
300 . . . Joined article
400 . . . Joined article
432, 442, 452, 462 . . . Annular groove (groove portion)
432a . . . Inner wall surface
432b . . . Inner wall surface
432c . . . Bottom surface
433 . . . Hole portion
435 . . . Anti-rotation rib
436a . . . Tapered surface
436b . . . Tapered surface
437 . . . Outer tubular portion
439 . . . Cylindrical tubular portion
450 . . . Bolt
G₁ . . . Groove
G₂ . . . Groove
P . . . Protrusion

What is claimed is:

1. A metal element to be joined to a metal plate, comprising:
a flange-shaped part; and
a columnar part having a smaller diameter than the flange-shaped part, wherein
in a state where the columnar part is inserted into an insertion hole drilled in the metal plate, by applying pressure in an axial direction to deform and flow the metal plate in a compression direction at the flange-shaped part and to deform a part at a distal end edge of the columnar part to expand in diameter such that the columnar part receives the deformed and flowed metal, so as to join the metal element to the metal plate.

2. The metal element according to claim 1, wherein
a depressed-shaped portion is formed on a distal end surface of the columnar part.

3. The metal element according to claim 1, wherein
the flange-shaped part is formed into an inverted truncated cone shape.

4. A joining structure for joining a metal element to a metal plate, comprising:
a flange-shaped part; and
a columnar part having a smaller diameter than the flange-shaped part, wherein
in a state where the columnar part of the metal element is inserted into an insertion hole drilled in the metal plate, by applying pressure to the metal element in an axial direction to deform and flow the metal plate in a compression direction at the flange-shaped part and to deform a part at a distal end edge of the columnar part to expand in diameter to receive a deformed and flowed metal, so as to join the metal element to the metal plate.

5. A metal element to be joined to a resin plate or metal plate, the metal element comprising
a columnar part, wherein
a surface of the columnar part has a non-flat shape, and
in a state where the columnar part is inserted into an insertion hole drilled in a resin plate or metal plate, by applying pressure in an axial direction to expand a diameter of the columnar part and to bring the columnar part into pressure contact with only an inner surface of the insertion hole of the resin plate or metal plate, so as to join the metal element to the resin plate or metal plate.

6. The metal element according to claim 5, wherein
a surface of the columnar part is provided by diamond-pattern uneven processing.

7. The metal element according to claim 5, wherein
the columnar part is hollow or has both front and back surfaces or one surface formed into a depressed shape.

8. A joining structure for joining a metal element to a resin plate or metal plate, wherein
the metal element includes a columnar part, wherein
a surface of the columnar part has a non-flat shape, and
in a state where the metal element is inserted into an insertion hole drilled in a resin plate or metal plate, by applying pressure in an axial direction to expand a diameter of the columnar part of the metal element and to bring the columnar part into pressure contact with only an inner surface of the insertion hole drilled in the resin plate or metal plate, so as join the metal element to the resin plate or metal plate.

9. A joined article comprising:
an annular metal element to be joined to a resin plate or metal plate having an insertion hole; and
a fastening member, wherein
in a state where the metal element is inserted through the insertion hole and in a state where the fastening member is inserted through the metal element, by compressing the metal element to increase an outer diameter and decrease an inner diameter of the metal element, so as to join the metal element to an inner surface of the insertion hole to be coupled to the fastening member.

10. The joined article according to claim 9, wherein
the fastening member includes a shaft portion to be inserted through the metal element, and
a male thread portion is disposed in at least a part of a region, and the region lies out of the metal element in the shaft portion.

11. The joined article according to claim 9, wherein
a groove portion is formed in the fastening member, and
in a state where the metal element is inserted through the insertion hole and in a state where an end portion of the metal element enters the groove portion, by compressing the metal element to increase an outer diameter and decrease an inner diameter of the metal element, so as to join the metal element to an inner surface of the insertion hole to be coupled to the fastening member.

12. A manufacturing method for manufacturing a joined article in which an annular metal element and a fastening member are joined to a resin plate or metal plate including an insertion hole, the manufacturing method comprising
in a state where the metal element is inserted through the insertion hole and in a state where the fastening member is inserted through the metal element, compressing the metal element to increase an outer diameter and decrease an inner diameter of the metal element, so as to join the metal element to an inner surface of the insertion hole to be coupled to the fastening member.
